(19) United States
(12) Patent Application Publication
(10) Pub. No.: US 2025/0336253 A1
(43) Pub. Date: Oct. 30, 2025

(54) CURRENCY HANDLING DEVICE

(71) Applicant: Glory Ltd., Himeji-shi (JP)

(72) Inventor: Takahisa FUJII, Himeji-shi (JP)

(73) Assignee: Glory Ltd., Himeji-shi (JP)

(21) Appl. No.: 19/188,062

(22) Filed: Apr. 24, 2025

(30) Foreign Application Priority Data
Apr. 25, 2024 (JP) 2024-071892

(51) Int. Cl. G07D 11/22; G07D 11/14; G07D 11/18; G07D 11/245; G07D 11/50

(52) U.S. Cl. CPC G07D 11/22; G07D 11/14; G07D 11/18; G07D 11/245; G07D 11/50; G07D 2201/00; G07D 2211/00

(57) ABSTRACT

A currency processing device comprises a deposit port that receives currency; a transport which transports the currency fed from the deposit port along the transport path; a recognition sensor that recognizes the currency transported on the transport path as normal or abnormal; a currency storage to store the currency; a reject port for returning the currency; and processing circuitry. The processing circuitry is configured to control the transport to transfer the currency recognized as normal by the recognition sensor to the currency storage for storage in the currency storage, and control the transport to transport the currency recognized as abnormal by the recognition sensor to be recirculated along the transport path to the recognition sensor to re-recognize the currency at least once, and to return the currency to the reject port based on a result of re-recognition by the recognition sensor.

### CROSS-REFERENCE TO RELATED APPLICATION

This application claims priority under 35 U.S.C. Section 119 of Japanese Patent Application No. 2024-071892 filed Apr. 25, 2024, entitled “Currency handling device”. The disclosure of the above application is incorporated herein by reference.

### BACKGROUND

In conventional currency processing devices such as currency depositing and dispensing machines and change machines, deposited currency is identified by an identification unit, currency identified as normal is stored in a currency storage unit such as a temporary holding unit or a denomination-specific storage unit, and currency identified as abnormal is returned as rejected currency to a return port unit such as a reject port or a withdrawal port. When rejected currency is returned, the rejected currency or a replacement currency is re-input into the device.

### SUMMARY

A currency handling device according to a main aspect of the present disclosure includes a currency processing device comprising a deposit port that receives currency inserted from outside of the currency processing device; a transport including a circular transport path, the transport transporting the currency fed from the deposit port along the transport path; a recognition sensor that recognizes the currency fed from the deposit port and transported on the transport path as one of normal and abnormal; a currency storage in which the currency is stored; a reject port for returning the currency; and processing circuitry configured to control a currency storing process for storing the currency accepted by the deposit port into the currency storage, wherein to execute the currency storing process, the processing circuitry is configured to control the transport to transfer the currency recognized as normal by the recognition sensor to the currency storage for storage in the currency storage, and control the transport to transport the currency recognized as abnormal by the recognition sensor to be recirculated along the transport path to the recognition sensor to re-recognize the currency at least once, and to return the currency to the reject port based on a result of re-recognition by the recognition sensor.

### BRIEF DESCRIPTION OF THE DRAWINGS

FIG. 1 is a perspective view of a coin processing device as viewed from above and in the front.

FIG. 2 is a perspective view of the coin processing device as viewed from below and in front.

FIG. 3 is a plan view showing a configuration of a coin processing unit.

FIGS. 4A and 4B are diagrams for explaining a configuration of a position detection mechanism.

FIG. 5A is a perspective view of a storage section, and FIG. 5B is a perspective view of a cam, an inner guide member, and an outer guide member.

FIG. 6 is a side cross-sectional view showing the configuration of a rear portion of a front panel.

FIG. 7 is a block diagram showing a main configuration of a coin processing device.

FIGS. 8A to 8C are diagrams for explaining a deposit process.

FIGS. 9A to 9C are diagrams for explaining a deposit process.

FIGS. 10A and 10B are diagrams for explaining a deposit process.

FIG. 11 is a flowchart illustrating a coin storing process executed by a control unit.

FIG. 12 is a flowchart illustrating a feed process executed by a control unit.

FIG. 13 is a flowchart illustrating a state information update process executed by a control unit.

FIGS. 14A and 14B are diagrams for explaining a dispensing process, and FIG. 14C is a diagram for explaining a collecting process.

FIG. 15 is a flowchart illustrating a control process executed by a control unit for a reconciliation process.

FIG. 16 is a flowchart showing a return process executed by the control unit when returning coins from the receiving unit to the storage unit in the reconciliation process.

FIGS. 17A and 17B are diagrams for explaining the reconciliation process.

FIG. 18 is a flowchart showing a coin storing process executed by a control unit according to a first modified example.

FIG. 19 is a flowchart illustrating a specified number of times setting process executed by a control unit according to a second modified example.

FIG. 20A is a flowchart showing a re-identification on/off setting process executed by a control unit according to Modification Example 3. FIG. 20B is a flowchart showing a coin storage process executed by a control unit according to Modification Example 3.

FIG. 21A is a flowchart showing a coin storing process executed during a deposit process and a coin storing process executed during a replenishment process according to Modification Example 4. FIG. 21B is a flowchart showing a coin storing process executed during a replenishment process according to Modification Example 5.

FIG. 22A is a cross-sectional view showing the configuration of a payout outlet and a receiving section according to Modification Example 6.

FIG. 22B is a flowchart showing the control process executed by the control section in the payout process according to Modification Example 6.

FIGS. 23A and 23B are diagrams for explaining the payout process according to the sixth modified example.

FIG. 24 is a flowchart showing a coin storing process executed by a control unit during a deposit process according to a seventh modified example.

FIGS. 25A and 25B are diagrams for explaining a coin storage process during a deposit process according to Modification Example 7.

FIG. 26 is a flowchart illustrating an inspection interruption process executed by a control unit according to a Modification Example 8.

### DETAILED DESCRIPTION

A currency handling device according to a main aspect of the present disclosure includes a conveying unit that includes a circular conveying path along which currency can circulate and conveys currency along the conveying path, a deposit unit that accepts currency inserted from outside and feeds it out to the conveying path, a recognition unit that identifies currency fed out from the deposit unit and conveyed along the conveying path, a currency storage unit that stores the currency, a return port unit that returns the currency, and a control unit that executes a currency storage process that stores the currency accepted by the deposit unit in the currency storage unit. Here, the control unit, in the currency storage process, causes currency identified as normal by the recognition unit to be stored in the currency storage unit by the conveying unit, causes currency identified as abnormal by the recognition unit to be circulated around the conveying path by the conveying unit and to be re-identified by the recognition unit at least once, and causes the currency to be returned to the return port unit based on the result of the re-identification.

According to the currency handling device of this aspect, currency that is originally normal can be easily identified as normal currency by re-identification, and can be easily stored in the currency storage section. Therefore, currency is less likely to be returned to the return port section.

In the currency handling device according to the present aspect, the control unit. The system can be configured so that coins that have been identified as abnormal less than the specified number of times (i.e., multiple times) are circulated around the conveying path and re-identified by the recognition unit, and coins that have been identified as abnormal more than once are returned to the return port unit.

According to the above configuration, money that is originally abnormal can be returned to the return port section when the number of times that the abnormality is identified reaches a specified number.

In the above configuration, the control unit can be configured to execute a notification process to notify the user that the returned coin cannot be used when the coin is returned to the return port unit.

With this configuration, users can more easily prepare replacement currency of the same denomination as the returned currency and reinsert it into the currency processing device.

In the case of the above configuration, the control unit can be further configured to receive a number of times input to an input unit as the specified number of times, and to set the received number of times to the specified number of times.

With this configuration, the number of re-recognitions performed by the recognition unit before returning abnormal currency to the return port unit can be set to a desired number.

In the case of the above configuration, the currency storage process may further include a deposit process for storing deposited currency in the currency storage unit, and a replenishment process for storing currency for replenishment in the currency storage unit. In this case, the control unit may be configured to set the specified number of times in the replenishment process to be less than the specified number of times in the deposit process.

With this configuration, it becomes easier to optimize the number of times that recognition is required in the recognition unit before currency identified as abnormal is returned, depending on whether the process being performed is a deposit process or a replenishment process.

In the currency handling device according to this aspect, the currency storage process includes a deposit process for storing deposited currency in the currency storage unit, and a replenishment process for storing replenishment currency in the currency storage unit.

In this case, in the deposit process, the control unit causes the transport unit to circulate the money identified as abnormal by the recognition unit around the transport path and causes the money to be re-identified by the recognition unit, and in the replenishment process, causes the control unit to return the money identified as abnormal by the recognition unit to the return port unit without causing the money to be re-identified by the recognition unit.

According to the above configuration, the number of times that recognition is required by the recognition unit before currency identified as abnormal is returned can be easily optimized depending on whether the process being executed is a deposit process or a replenishment process.

In the currency processing device of this disclosure, the control unit can be configured to accept either an on or off setting for re-identification by a recognition unit, input to the input unit, and when the on setting is accepted, to cause the currency identified as abnormal by the recognition unit to be re-identified by the recognition unit by circulating the currency around the conveying path by the conveying unit, and when the off setting is accepted, to return the currency identified as abnormal by the recognition unit to the return port unit without being re-identified by the recognition unit.

According to the above configuration, it is possible to determine whether or not to re-identify currency that has been identified as abnormal, depending on the application of the currency handling device.

The currency processing device according to this aspect may be configured to perform an inspection process for inspecting currency stored in the currency storage unit. In this case, the recognition unit may have a function of identifying and counting currency. The control unit may be configured to, in the inspection process, cause the recognition unit to identify and count currency transported on the transport path, cause currency identified as abnormal by the recognition unit to be re-identified by the recognition unit at least once by circulating the transport path with the transport unit, and determine the currency as rejected currency based on the result of the re-identification.

According to the above configuration, since a currency that is originally normal can be easily identified as normal currency by re-identification, discrepancies in the cash data caused by rejected currency are less likely to occur. This can reduce the frequency with which the inspection process needs to be repeated.

When the above configuration is adopted, the control unit can be further configured to, if the result of re-identification by the recognition unit is that the coin identified as abnormal is determined to be a rejected coin, notify the user that the amount of coin in the coin storage unit does not match the amount data due to the occurrence of a rejected coin.

In addition, the control unit may determine that a coin identified as abnormal as a result of a single re-identification is a rejected coin, or may determine that a coin identified as abnormal as a result of multiple re-identifications is a rejected coin.

With this configuration, staff members or the like can understand that a discrepancy has occurred with the cash on hand data due to a rejected coin.

In the currency handling device according to this aspect, the currency accepted by the deposit unit may be coins. In this case, the transport unit may be configured to include a circulating belt that has a plurality of protrusions at predetermined intervals for transporting coins and that rotates on the transport path. The currency handling device may further include a memory unit that stores, for each of the protrusions, status information for determining whether the protrusion is transporting a coin. The control unit may be configured to store, in the memory unit, information indicating that a coin is being transported as the status information when a coin is dispensed from the deposit unit to the protrusion while the circulating belt is rotating, and to store, in the memory unit, information indicating that a coin is not being transported as the status information when the coin being transported by the protrusion is separated from the protrusion, and to control the deposit unit to dispense a coin to the protrusion that is determined not to be transporting a coin based on the status information.

According to the above configuration, it is possible to prevent new coins from being dispensed from the deposit section to the protrusion that is already holding coins.

Hereinafter, a coin processing device which is one example of the currency processing device of the present disclosure will be described with reference to the drawings.

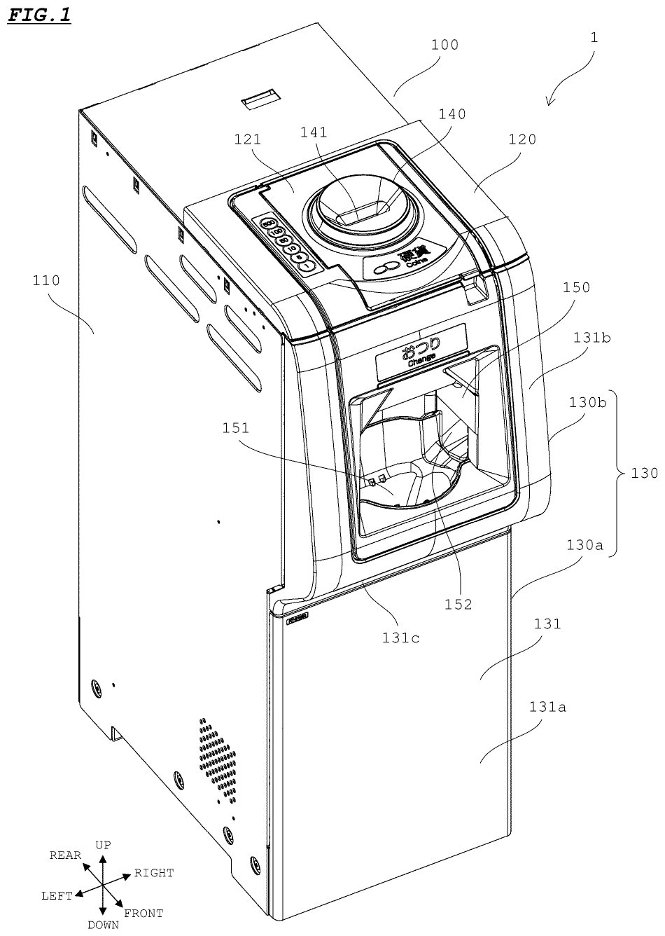

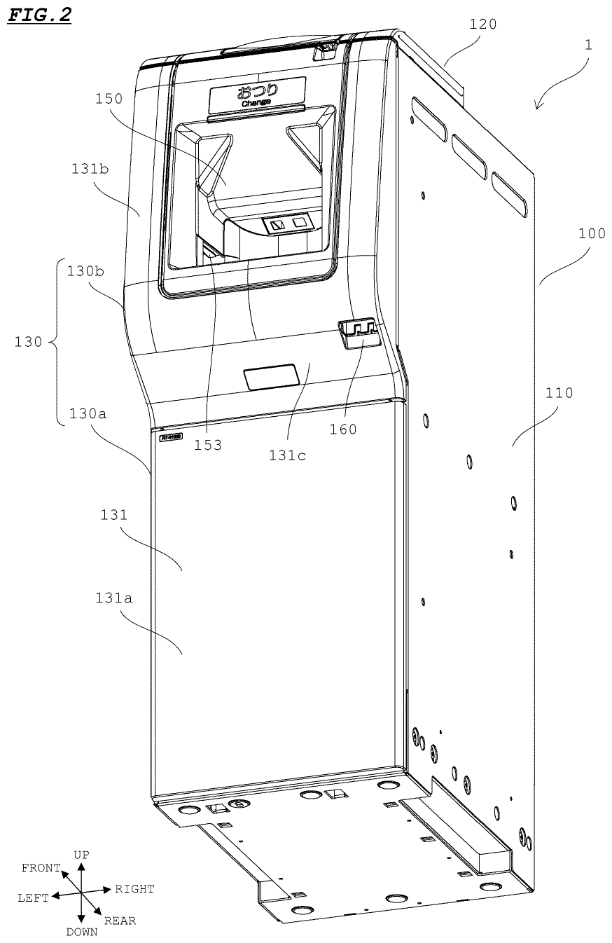

FIG. 1 is a perspective view of the coin processing device 1 as viewed from above and in the front. FIG. 2 is a perspective view of the coin processing device 1 as viewed from below and in the front.

The coin processing device 1 processes coins, such as depositing and dispensing. The coin processing device 1 is combined with an information terminal device for performing settlement operations for transaction objects such as merchandise, and a banknote processing device for performing processes such as depositing and dispensing banknotes, to constitute a self-checkout device or semi-self-checkout device installed in a retail store such as a supermarket, or an automatic payment device (kiosk) installed in a restaurant, etc. In this case, the coin processing device 1 functions as a coin change machine, accepting deposits of coins that are the fees for transaction objects such as merchandise, and dispensing coins that are the change.

The coin processing device 1 has a housing 100 that forms an outer shell. The housing 100, i.e., the coin processing device 1, has a substantially rectangular parallelepiped shape with a depth dimension (front-rear direction) greater than a width dimension (left-right direction) and a height dimension (up-down direction) greater than the depth and width dimensions. The housing 100 includes a main body 110 with openings on the front side and front surface of the top surface, a top panel 120 that covers the opening on the top surface of the main body 110, and a front panel 130 that covers the opening on the front surface of the main body 110. A front surface 131 of the front panel 130 is the front surface of the housing 100, i.e., the coin processing device 1.

Top panel 120 has a top lid 121. Top lid 121 can be opened upwards around its rear end. Top panel 120 has a deposit port 140 provided on top lid 121. Deposit port 140 has a round shape, and has a substantially rectangular insertion port 141 in the center through which coins are inserted. Deposit port 140 is recessed in a mortar shape toward insertion port 141.

Coins can be inserted one by one through the insertion port 141. The coins are stored in a hopper 210 disposed below the insertion port 141. Furthermore, by manually opening the top lid 121, a larger number of coins can be directly inserted into the hopper 210.

The front panel 130 is composed of a lower first member 130a and an upper second member 130b. The first member 130a has a substantially rectangular plate shape. The second member 130b has a rectangular shape when viewed from the front, is thicker in the front-rear direction than the first member 130a, and is configured so that its thickness increases toward the bottom. Due to the configuration of the front panel 130, the upper side of the housing 100, i.e., the front surface 131 of the coin processing device 1, bulges forward.

The front surface 131 of the coin processing device 1 (front surface of the front panel 130) includes a first surface 131a, a second surface 131b located above the first surface 131a and projecting forward from the first surface 131a, and a downwardly facing third surface 131c connected to the second surface 131b and the first surface 131a. The second surface 131b is inclined slightly backward with respect to the vertical direction. The third surface 131c faces obliquely downward toward the front. The corner between the second surface 131b and the third surface 131c has a large R.

A dispensing outlet section 150 is provided on a second surface 131b of the front surface 131 of the coin processing device 1. The dispensing outlet section 150 is formed in a hollow shape recessed toward the rear, and has a tray 151 for receiving coins at the bottom. A dispensing outlet 152 is provided on the right side surface of the dispensing outlet section 150. Coins that are dispensed as change from the storage unit 500 are discharged from the dispensing outlet 152 and stored in the tray 151.

Furthermore, a reject port 153 is provided on the left side surface of the dispensing outlet section 150. Abnormal rejected coins inserted from the insertion port 141 are discharged from the reject port 153 and accumulated in the tray 151. In other words, the dispensing outlet section 150 also functions as a return port through which coins, which are currency, are returned as rejected coins. The coins returned to the dispensing outlet section 150 can be taken out.

A collection outlet section 160 is provided at the right end of the third surface 131c of the front surface 131 of the coin processing device 1. The collection outlet section 160 is a substantially rectangular opening. Coins collected from the storage unit 500 are discharged downward from the collection outlet section 160.

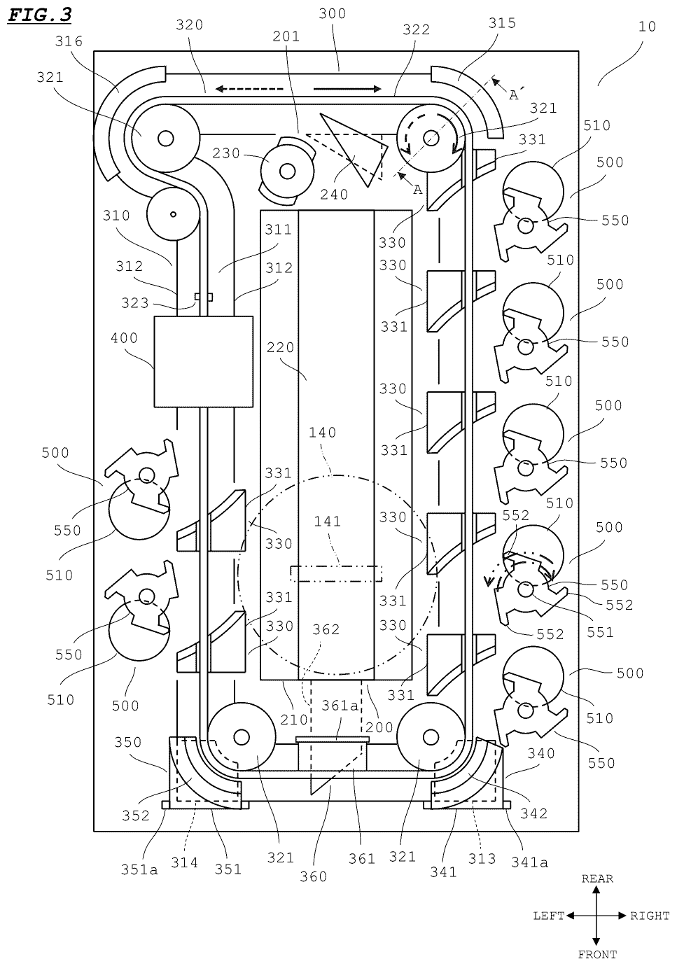

FIG. 3 is a plan view showing the configuration of the coin processing unit 10. For convenience, in FIG. 3, the deposit port 140 is shown by a two-dot chain line.

The coin processing unit 10 is disposed inside the housing 100. A front panel 130 is fixed to the front of the coin processing unit 10. This integrates the coin processing unit 10 and the front panel 130. The coin processing unit 10 together with the front panel 130 can be pulled out toward the front of the housing 100, i.e., the main body 110.

The coin processing unit 10 has a receiving unit 200, a transport unit 300, a recognition unit 400, and seven (multiple) storage sections 500.

The receiving unit 200 is disposed below the deposit port 140, and receives coins inserted from the insertion port 141, and delivers the coins one by one to the transport path 310 of the transport unit 300. The receiving unit 200 includes a hopper 210, a conveyor 220, a feeding cam 230, and an opening/closing member 240. The conveyor 220, the feeding cam 230, and the opening/closing member 240 are each driven by one or more drive mechanism including one or more drive source. The hopper 210 receives the inserted coins. The conveyor 220 is disposed at the bottom of the hopper 210, and delivers the coins to the feeding cam 230 side at the rear. The feeding cam 230 delivers the coins received from the conveyor 220 to the transport path 310 through the outlet 201. The opening/closing member 240 opens the outlet 201 (solid line in FIG. 3) when coins are to be dispensed from the receiving unit 200 to the transport path 310, and closes the outlet 201 (dashed line in FIG. 3) when coins are not to be dispensed. The receiving unit 200 may be a deposit slot, deposit port, receptacle or other deposit unit that accepts coins, which are currency inserted from the outside, and dispenses them to the transport path 310.

The transport unit 300 transports the coins fed from the receiving unit 200 to each storage unit 500. The transport unit 300 also transports the coins dispensed from each storage unit 500 to a dispensing outlet 313 connected to the dispensing outlet section 150 and the collection outlet section 160. The transport unit 300 has a transport path 310, a transport mechanism 320, seven (plural) storage and branching mechanisms 330, a dispensing diverting mechanism 340, a reject diverting mechanism 350, and a hopper diverting mechanism 360.

The transport path 310 is formed around the receiving unit 200 in a long ring shape in the front-rear direction. This allows the coins to go around the circular transport path 310. The transport path 310 has side walls 312 on both sides of its conveying surface 311 so that the coins do not fall off the transport path 310. The transport path 310 has a substantially square-shaped dispensing outlet 313 at the right front corner and a substantially square-shaped reject outlet 314 at the left front corner. The entrance of a chute 362 connected to the hopper 210 is connected to the front center of the transport path 310. Furthermore, corner guides 315 and 316 are arranged on the outer periphery of the corners on the right rear side and the left rear side of the transport path 310, respectively. The corner guides 315 and 316 extend in an arc shape along the outer periphery of the corners.

The transport mechanism 320 has four pulleys 321 and a circulation belt 322. The four pulleys 321 are disposed inside the four corners of the transport path 310. The circulation belt 322 has a long circular in the front-rear direction, and is placed above the conveying surface 311 by being stretched between the four pulleys 321. A plurality of protrusions 323 for conveying coins are provided at equal intervals on the lower surface of the circulation belt 322. The number of protrusions 323 may be, for example, about 10. Note that only one protrusion 323 is shown in FIG. 3.

Power is transmitted to one pulley 321 from the drive motor of the transport mechanism 320, and the pulley 321 rotates clockwise or counterclockwise. As shown by the solid arrow in FIG. 3, when the pulley 321 rotates clockwise, the circulation belt 322 rotates clockwise, and the coins on the transport path 310 move clockwise as if pushed by the protrusions 323 of the circulation belt 322. On the other hand, as shown by the dashed arrow in FIG. 3, when the pulley 321 rotates counterclockwise, the circulation belt 322 rotates counterclockwise, and the coins on the transport path 310 move counterclockwise. During a deposit process, the circulation belt 322 rotates counterclockwise, and during a withdrawal process (dispensing process, collection process), the circulation belt 322 rotates clockwise.

The seven storage diverting mechanisms 330 each have a diverting member 331, and distribute coins flowing through the transport path 310 to the corresponding storage units 500. Five diverting members 331 are arranged in a line in the front-rear direction in a portion between the front and rear pulleys 321 on the right side of the transport path 310. The positions of the five diverting members 331 correspond to the five storage units 500, respectively. Two diverting members 331 are arranged in a line in the front-rear direction in a portion between the left front pulley 321 and the recognition unit 400 in the transport path 310. The positions of the two diverting members 331 correspond to the two storage units 500, respectively. Each diverting member 331 is switched between a state in which it protrudes from the conveying surface 311 and a state in which it does not protrude from the conveying surface 311 by a drive mechanism including a drive source.

The dispensing diverting mechanism 340 has a diverting member 341. The diverting member 341 covers the dispensing outlet 313 on the outer side of the circulation belt 322. This closes the dispensing outlet 313 to such an extent that coins do not enter. The diverting member 341 is opened and closed in the vertical direction about its rotation shaft 341a by a drive mechanism including a drive source. When the diverting member 341 is opened to open the dispensing outlet 313, coins can enter the dispensing outlet 313. The diverting member 341 is provided with a corner guide portion 342 at a position that is the outer periphery of the right front corner of the transport path 310. The corner guide portion 342 extends in an arc shape along the outer periphery of the corner portion.

The reject diverting mechanism 350 has a diverting member 351. The diverting member 351 covers the reject outlet 314 on the outer side of the circulation belt 322. This closes the reject outlet 314 to the extent that coins cannot enter. The diverting member 351 is opened and closed in the vertical direction about its rotation shaft 351a by a drive mechanism including a drive source. When the diverting member 351 is opened to open the reject outlet 314, coins can enter the reject outlet 314. The diverting member 351 is provided with a corner guide portion 352 at a position that is the outer periphery of the left front corner of the transport path 310. The corner guide portion 352 extends in an arc shape along the outer periphery of the corner portion.

The hopper diverting mechanism 360 has a diverting member 361 and a chute 362. The chute 362 has an inlet connected to the transport path 310 and is inclined downward toward the rear toward the hopper 210 of the receiving unit 200. The diverting member 361 covers the inlet of the chute 362 on the inner side of the circulation belt 322. This closes the inlet of the chute 362 to such an extent that coins cannot enter. The diverting member 361 is opened and closed in the vertical direction about its rotation shaft 361a by a drive mechanism including a drive source. When the diverting member 361 is opened to open the inlet of the chute 362, coins can fall into the hopper 210 through the chute 362.

The transport unit 300 has a position detection mechanism 370 for detecting the distance between the two protrusions 323 of the circulation belt 322 on the transport path 310, that is, the distance between the protrusions.

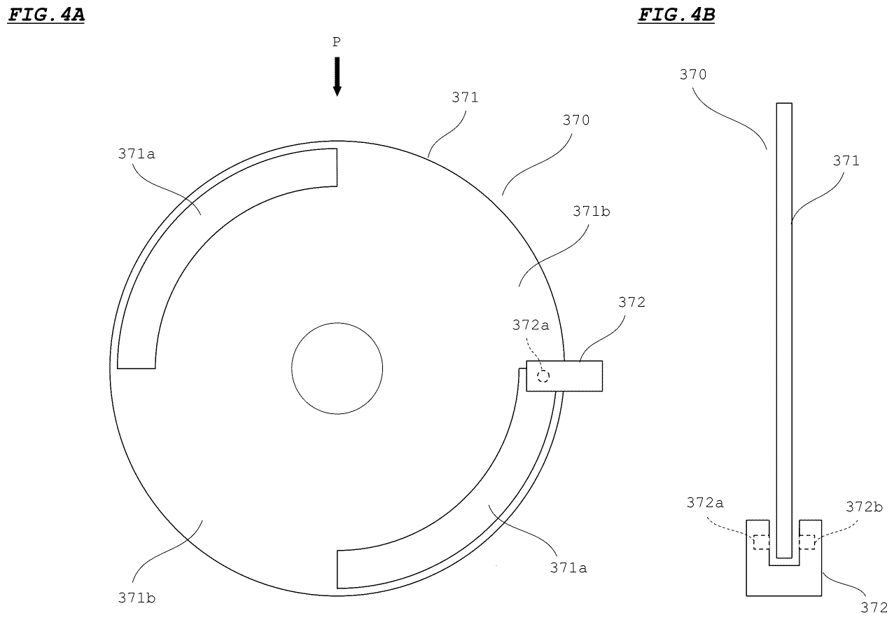

FIGS. 4A and 4B are diagrams for explaining the configuration of the position detection mechanism 370. FIG. 4A is a diagram of the position detection mechanism 370 seen from the front of the light shielding plate 371, and FIG. 4B is a diagram of the position detection mechanism 370 seen from the P direction in FIG. 4A. The position detection mechanism 370 has a light shielding plate 371 and a photosensor 372. The light shielding plate 371 has a disk shape, is connected to one pulley 321 via a reduction gear mechanism, and rotates in conjunction with the circulation belt 322, making one rotation when the circulation belt 322 rotates once.

At the outer peripheral edge of the light shielding plate 371, light transmitting sections 371a and light-shielding sections 371b are alternately formed in the circumferential direction, and the number of spaces between the protrusions of the circulation belt 322 is equal to the length between the protrusions of the circulation belt 322. The lengths of the light transmitting sections 371a and the light-shielding sections 371b are the lengths between the protrusions. The light transmitting sections 371a are formed, for example, by openings. The light transmitting sections 371a may also be formed by notches.

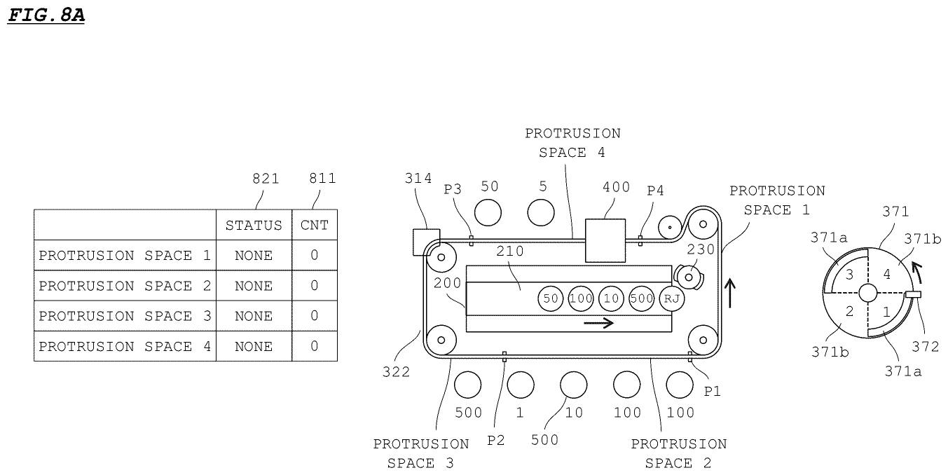

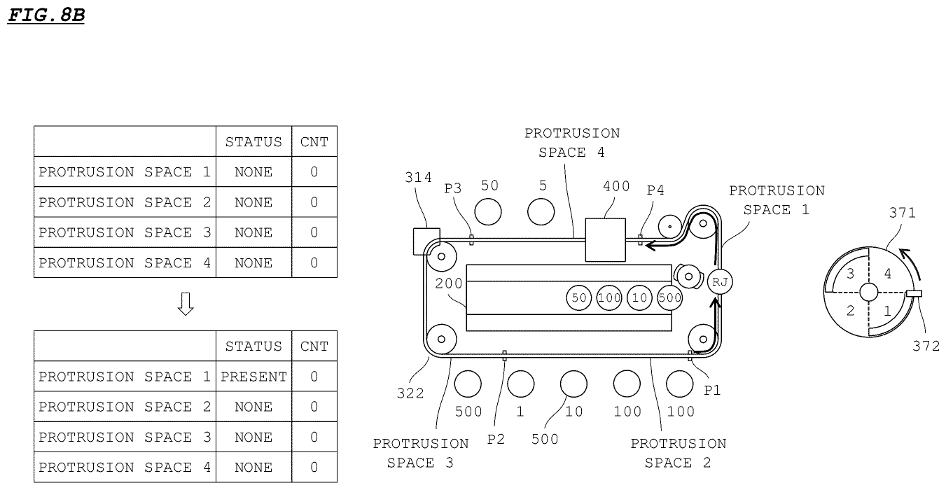

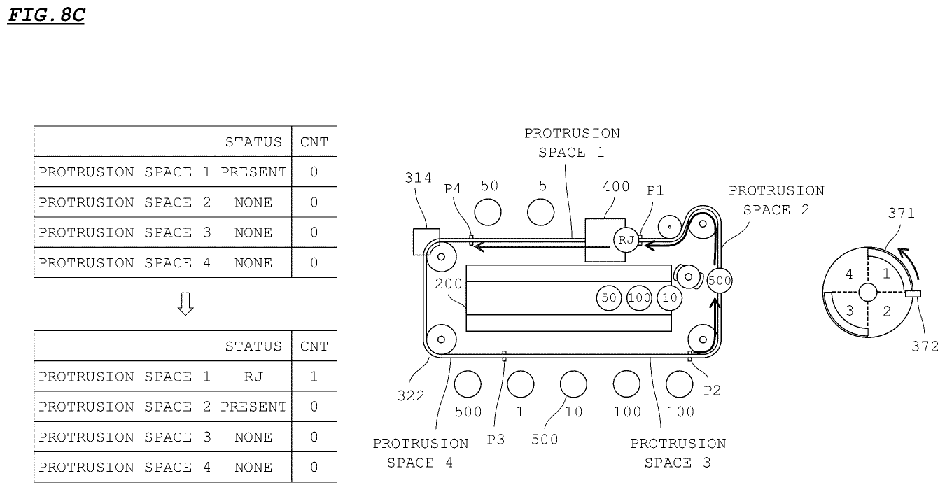

In FIG. 4A, in accordance with the explanation of the deposit process using FIGS. 8A to 10B to be given later, the circulation belt 322 has four protrusions 323, and therefore has four protrusion spaces, and therefore the light shielding plate 371 has two light transmitting sections 371a and two light shielding sections 371b. However, in reality, the number of protrusions 323 of the circulation belt 322 is greater than the above (for example, about 10). Therefore, the number of light transmitting sections 371a and light shielding sections 371b of the light shielding plate 371 is greater than the above.

The photosensor 372 has a light-emitting element 372a and a light-receiving element 372b, and is disposed on the outer peripheral edge of the light shielding plate 371. While the light transmitting section 371a of the light shielding plate 371 passes the position of the photosensor 372, the light from the light-emitting element 372a passes through the light transmitting section 371a and reaches the light-receiving element 372b. This allows the light transmitting section 371a to be detected by the photosensor 372. While the light-shielding section 371b of the light shielding plate 371 passes the position of the photosensor 372, the light from the light-emitting element 372a is blocked by the light-shielding section 371b and does not reach the light-receiving element 372b. This allows the light-shielding section 371b to be detected by the photosensor 372. In this way, while the circulation belt 322 is rotating, the position detection mechanism 370 detects the gaps between the protrusions of the circulation belt 322 in order.

Returning to FIG. 3, the recognition unit 400 is disposed on the transport path 310 between the left rear pulley 321 and the diverting member 331. The recognition unit 400 is configured with sensors such as optical sensors or magnetic sensors, and recognizes the attributes of coins flowing on the transport path 310 and outputs the recognition results. The recognized attributes include the coin's authenticity, denomination, and fitness. The seven storage diverting mechanisms 330 and the reject diverting mechanism 350 operate according to the recognition results from the recognition unit 400. Furthermore, the recognition unit 400 also counts the coins.

As a result of the recognition by the recognition unit 400, coins that are genuine, undamaged, and whose denomination can be identified are determined to be normal coins, while counterfeit coins, damaged coins, or coins whose denomination cannot be identified are determined to be abnormal coins.

The seven storage units 500 store coins fed from the receiving unit 200 and transported along the transport path 310 during a deposit process, and feed coins one by one onto the transport path 310 during a withdrawal process (during a dispensing process or a collecting process). Coins are stored in each storage unit 500 by denomination.

For example, six storage units 500 are assigned to 500 yen coins, 100 yen coins, 50 yen coins, 10 yen coins, 5 yen coins, and 1 yen coins, respectively, and the remaining storage unit 500 is assigned to 100 yen coins and 10 yen coins. Note that it is also possible to adopt an operation in which coins of mixed denominations are stored in some or all of the storage units 500. The storage unit 500 is a currency storage unit that stores coins, which are currency.

Two storage units 500 are arranged on the left side of the transport path 310, substantially aligned left and right with their corresponding diverting members 331. In addition, five storage units 500 are arranged on the right side of the transport path 310, substantially aligned left and right with their corresponding diverting members 331.

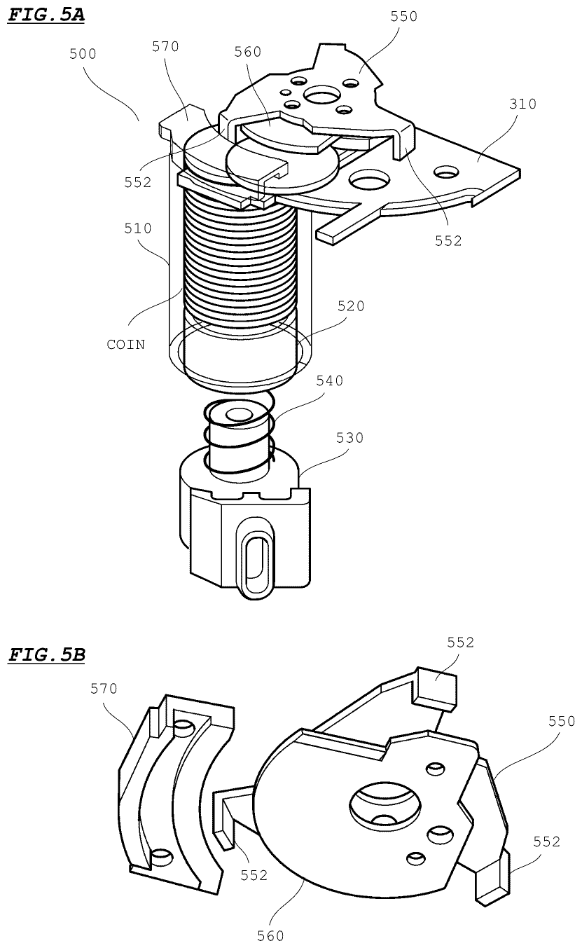

FIG. 5A is a perspective view of the storage unit 500, and FIG. 5B is a perspective view of the cam 550, the inner guide member 560, and the outer guide member 570. In FIG. 5A, the outer guide member 570 and the housing 510 are shown in a transparent state. Furthermore, in FIG. 5A, the housing 510 is drawn short in the vertical direction.

As shown in FIGS. 5A and 5B, each storage unit 500 includes a housing 510, a stage 520, a lifting member 530, a spring 540, a cam 550, an inner guide member 560, and an outer guide member 570.

The housing 510 has a cylindrical shape that extends long in the vertical direction. The stage 520 is disposed within the housing 510. A plurality of coins are stored within the housing 510 in a stacked state on the stage 520. The lifting member 530 is disposed below the stage 520. A spring 540 is interposed between the stage 520 and the lifting member 530. A linear motor is attached to the lower part of the lifting member 530, and the lifting member 530 is lifted and lowered by the operation of the linear motor. When the lifting member 530 is lifted and lowered, the stage 520 is lifted and lowered.

Cam 550 is disposed near the entrance of housing 510. Cam 550 rotates about a rotation shaft 551 extending in the vertical direction by the driving force of a drive motor provided in storage unit 500. Cam 550 is provided with three protrusions 552 that protrude downward. During a deposit process, the cam 550 rotates clockwise as indicated by the dashed-dotted arrow in FIG. 3.

The coins flowing through the transport path 310 and sorted by the diverting member 331 to the storage unit 500 side are pushed by the protrusion 552 of the rotating cam 550 and stored in the storage unit 500, i.e., the housing 510. Each time a coin is stored in the housing 510, the stage 520 is lowered by the thickness of one coin. Each diverting member 331 protrudes so that the coins can be sorted to the storage unit 500 side when a passing sensor corresponding to each diverting member 331 arranged upstream in the rotation direction of the circulation belt 322 during the deposit process detects a coin.

During the dispensing process (payment process, collection process), the cam 550 rotates counterclockwise as shown by the two-dot chain line arrow in FIG. 3. The coin that has come out onto the housing 510 is pushed by the protrusion 552 of the rotating cam 550 and fed into the transport path 310. Each time a coin is fed by the cam 550, the stage 520 rises by the thickness of one coin.

The inner guide member 560 and the outer guide member 570 are disposed above the housing 510, and hold down the coins stacked on the stage 520 from above to prevent the coins from flying out from inside the housing 510. The inner guide member 560 is located below the cam 550, i.e., inside the cam 550, and the outer guide member 570 is located outside the cam 550. A gap is formed between the inner guide member 560 and the outer guide member 570, and the protrusion 552 of the cam 550 passes through the gap.

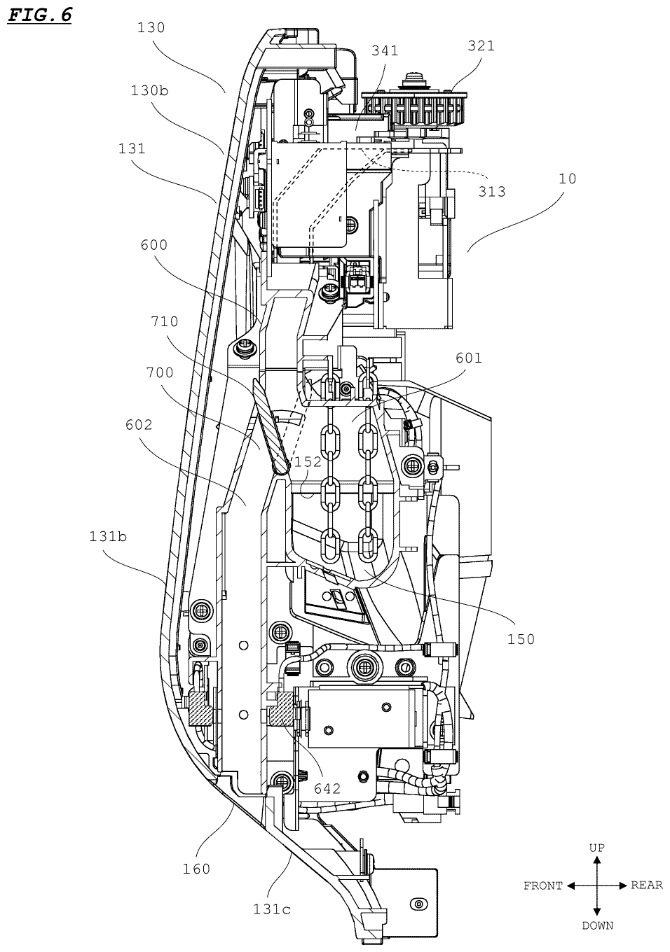

FIG. 6 is a side cross-sectional view showing the configuration of the rear portion of front panel 130.

In addition to the above configuration, the coin processing unit 10 also has a dispensing chute 600 and a path switching unit 700. The dispensing chute 600 is disposed between the dispensing outlet 313 of the transport path 310 and the dispensing outlet section 150 and the collection outlet section 160. The dispensing chute 600 extends downward from the dispensing outlet 313 and branches into two paths 601 and 602 midway. One path 601 is connected to the dispensing outlet section 150, and the other path 602 is connected to the collection outlet section 160.

The path switching unit 700 includes a diverting member 710 disposed at the branching point of the dispensing chute 600.

The diverting member 710 is driven by a drive mechanism including a drive source. When the diverting member 710 blocks the other path 602, the coins from the dispensing outlet 313 are guided to the dispensing outlet section 150, and when the diverting member 710 blocks one path 601, the coins from the dispensing outlet 313 are guided to the collection outlet section 160.

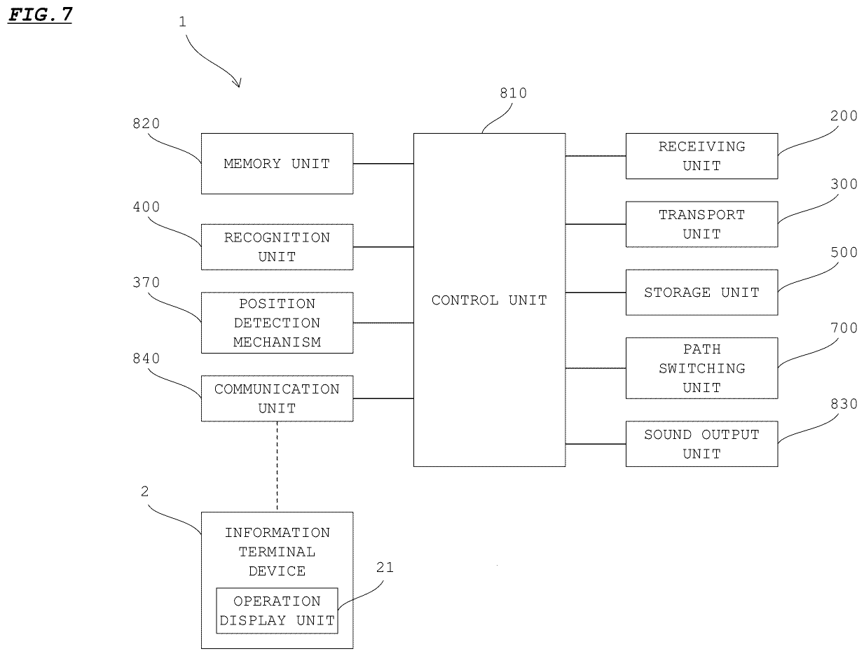

FIG. 7 is a block diagram showing the main configuration of the coin processing device 1.

In addition to the above-mentioned components, the coin processing device 1 has a control unit 810, a memory unit 820, a sound output unit 830, and a communication unit 840.

The sound output unit 830 includes a speaker and outputs sounds such as voice, an alarm sound, and a buzzer sound. The communication unit 840 communicates with the information terminal device 2. The information terminal device 2 has an operation display unit 21 consisting of a touch panel or the like, and the operation display unit 21 displays various screens and accepts various operations on the screens.

The control unit 810 has an arithmetic circuit such as a CPU (Central Processing Unit). The control unit 810 controls the receiving unit 200, the transport unit 300, the storage unit 500, the path switching unit 700, the sound output unit 830, the communication unit 840, and the like, in accordance with an operation program stored in the memory unit 820, based on each signal from the recognition unit 400, the position detection mechanism 370, and the like. Control unit 810 may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The memory unit 820 includes storage media such as a ROM (Read Only Memory), a RAM (Random Access Memory), and a hard disk, and stores the operation program for the control unit 810, and is also used as a work area during control processing by the control unit 810. Memory unit 820 may store a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, and/or the memory of a FPGA or ASIC.

When functioning as a coin change machine, the coin processing device 1 can execute a deposit process for accepting the deposit of coins that constitute the fee for the transaction, and a dispensing process for dispensing coins that constitute change. The coin processing device 1 can also execute a refill process for refilling the seven storage units 500 with coins, and a collection process for collecting coins from the seven storage units 500. Furthermore, the coin processing device 1 can execute a reconciliation process for reconciling whether the amount of coins stored in the seven storage units 500 matches the amount data stored in the memory unit 820. The dispensing process and the collection process are discharging processes for dispensing coins stored in the storage units 500 out of the coin processing device 1.

### <Deposit Processing>

FIG. 8A to 10B are diagrams for explaining the deposit process.

For the sake of convenience, the deposit process will be described below assuming that the number of protrusions 323 on the circulation belt 322 is four. Also, assume that the number of deposited coins is five, and that the first coin dispensed from the receiving unit 200 is a rejected coin.

During the deposit process, coins are inserted into the insertion port 141 of the deposit port 140. The inserted coins are stored in the hopper 210 of the receiving unit 200. The insertion of the coins is detected by an insertion detection sensor, and the deposit process is started. The conveyor 220 of the receiving unit 200 starts to operate, and the coins in the hopper 210 move to the position of the feeding cam 230. In addition, the circulation belt 322 starts to rotate counterclockwise, and the light shielding plate 371 rotates in conjunction with this.

FIG. 8A, when the photosensor 372 detects a change between the light transmitting section 371a and the light shielding section 371b of the light shielding plate 371, for example, a change from the light shielding section 371b to the light transmitting section 371a, among the four protrusion spaces of the circulation belt 322, the protrusion space at the position of the feeding cam 230, i.e., the position where the coin is paid out from the receiving unit 200, is assigned to the protrusion space 1, and the remaining three protrusion spaces in the opposite direction to the conveying direction of the circulation belt 322 are assigned to the protrusion space 2, the protrusion space 3, and the protrusion space 4. In addition, the protrusions 323 on the rear side in the conveying direction of the protrusion spaces 1 to 4 are assigned to the first protrusion P1 to the fourth protrusion P4, respectively. Furthermore, light transmitting section 371a detected by photosensor 372 is assigned to section 1, and in the reverse rotational direction from section 1, light-shielded section 371b, light transmitting section 371a, and light-shielded section 371b are assigned to sections 2, 3, and 4, respectively. Sections 1 to 4 correspond to protrusion spaces 1 to 4, respectively. The sections detected by photosensor 372 move with the movement of the spaces between the protrusions.

As shown in FIG. 8A, the memory unit 820 stores status information 821 associated with the protrusion spaces 1 to 4, i.e., the first protrusion P1 to the fourth protrusion P4. The control unit 810 also includes a count unit 811 associated with the protrusion spaces 1 to 4.

The status information 821 has “present” information indicating that a coin is present on the protrusion 323, denomination information indicating the denomination of the coin present on the protrusion 323, “RJ” information indicating that the coin present on the protrusion 323 is a rejected coin, and “absent” information indicating that no coin is present on the protrusion 323. The status information 821 can be used to determine whether or not the protrusion 323 is transporting a coin. That is, if “present” information, denomination information, or “RJ” information is stored as the status information 821, it can be determined that the protrusion 323 associated with the status information 821 is transporting a coin, and if “absent” information is stored as the status information 821, it can be determined that the protrusion 323 associated with the status information 821 is not transporting a coin.

The count unit 811 counts the number of times a coin is identified as an abnormal coin, i.e., a rejected coin (not confirmed), by the recognition unit 400. When the count value of the count unit 811 reaches a specified number, the coin is confirmed as a rejected coin and becomes eligible for return to the dispensing outlet section 150. In this explanation, the specified number is set to two times.

At the start of the deposit process, the status information 821 is “none” for all of the protrusion spaces 1 to 4, and the value of the count unit 811 is “0”.

As shown in FIG. 8B, while the photosensor 372 is detecting section 1, the first protrusion P1 passes through the position where the coin is fed from the receiving unit 200. Since the status information 821 for the protrusion space 1 is “absent”, it is determined that the first protrusion P1 is not transporting a coin. The coin is dispensed from the receiving unit 200 by the feeding cam 230 and transported by the first protrusion P1. The status information 821 for the protrusion space 1 is updated to “present” information.

Next, as shown in FIG. 8C, the photosensor 372 detects section 2. During this time, the first protrusion P1 passes the recognition unit 400, and the second protrusion P2 passes the feeding position. As a result of recognition by the recognition unit 400, the coin at the first protrusion P1 is recognized as an abnormal coin, i.e., a rejected coin, and the status information 821 for the protrusion space 1 is updated to “RJ” information. In addition, the value of the count unit 811 for the protrusion space 1 becomes “1”. As the status information 821 for the protrusion space 2 is “none”, the first protrusion P2 passes the feeding position.

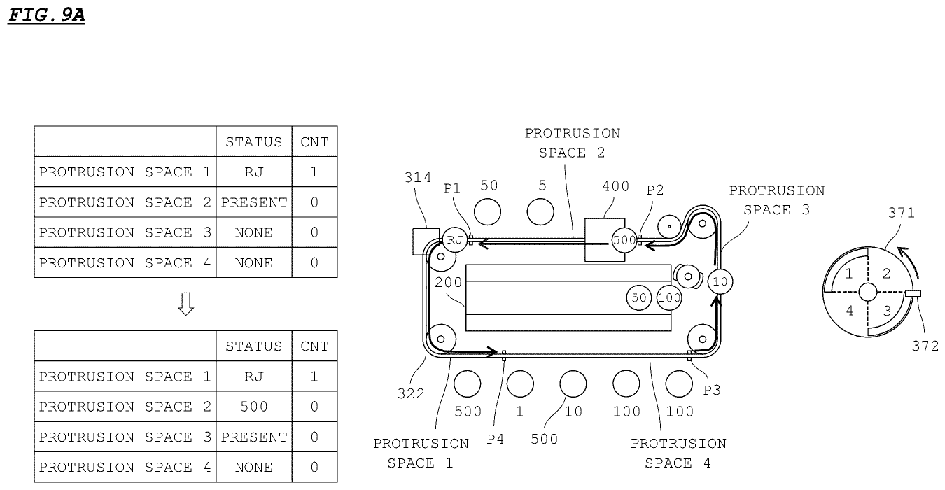

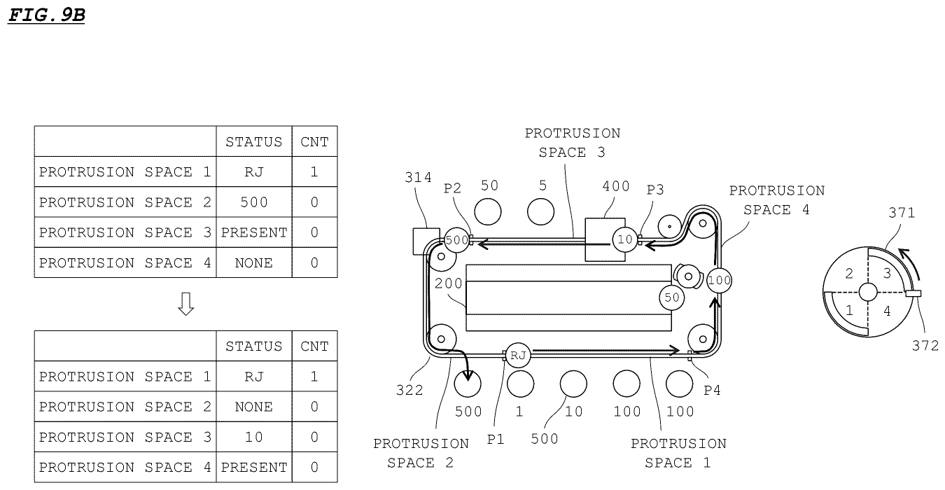

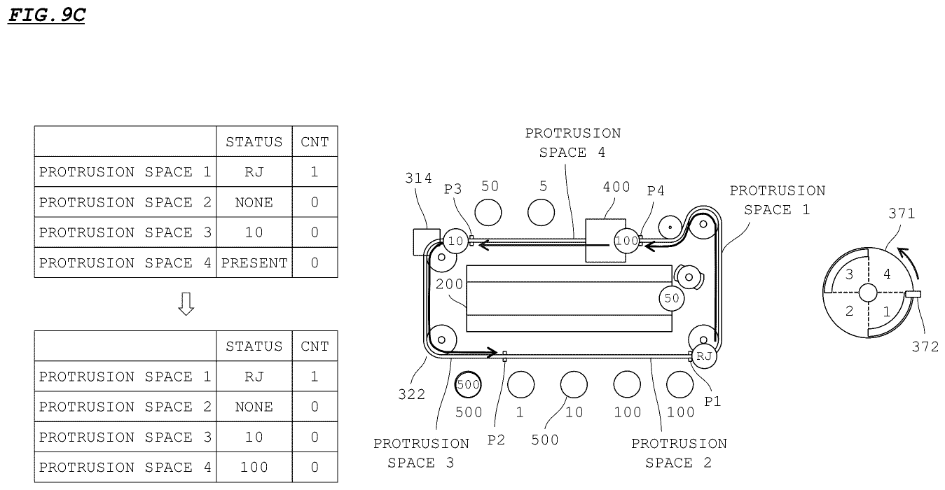

Next, as shown in FIG. 9A, the photosensor 372 detects the section 3. During this time, the first protrusion P1 passes through the reject outlet 314, the second protrusion P2 passes through the recognition unit 400, and the third protrusion P3 passes through the feeding position. The value of the count unit 811 for the coin at the first protrusion P1 is “1”, and it has not been determined that the coin is a rejected coin. Therefore, the reject outlet 314 is not opened, and the coin passes through the reject outlet 314 as it is. As a result of the recognition by the recognition unit 400, the denomination of the coin at the second protrusion P2 is recognized as 500 yen, and the status information 821 for the protrusion space 2 is updated to denomination information of “500”. Since the status information 821 for the protrusion space 3 is “none”, it is determined that the third protrusion P3 is not conveying a coin. The coin is fed from the receiving unit 200 and conveyed by the third protrusion P3. The state information 8 21 of the protrusion space 3 is updated to “present”.

Next, as shown in FIG. 9B, the photosensor 372 detects the section 4. During this time, the second protrusion P2 passes through the storage unit 500 to which the denomination of 500 yen is assigned, the third protrusion P3 passes through the recognition unit 400, and the fourth protrusion P4 passes through the feeding position. The 500 yen coin in the second protrusion P2 is stored in the storage unit 500, and the status information 821 in the protrusion space 2 is updated to “absent”. As a result of recognition by the recognition unit 400, the denomination of the coin in the third protrusion P3 is recognized as 10 yen, and the status information 821 in the protrusion space 3 is updated to “10” denomination information. Since the status information 821 in the protrusion space 4 is “absent”, it is determined that the fourth protrusion P4 is not conveying a coin. The coin is dispensed from the receiving unit 200 and conveyed by the fourth protrusion P4. The status information 821 in the protrusion space 4 is updated to “present”.

Next, as shown in FIG. 9C, the circulation belt 322 rotates once, the light shielding plate 371 rotates once, and the photosensor 372 detects section 1 again. During this time, the fourth protrusion P4 passes the recognition unit 400, and the first protrusion P1 passes the feeding position. As a result of recognition by the recognition unit 400, the denomination of the coin at the fourth protrusion P4 is recognized as 100 yen, and the status information 821 for the protrusion space 4 is updated to denomination information of “100”. Since the status information 821 for the protrusion space 1 is “RJ”, it is determined that the first protrusion P1 is currently transporting a coin. As a result, no coins are fed out from the receiving unit 200, and the first protrusion P1 passes the feeding position while holding the rejected coin.

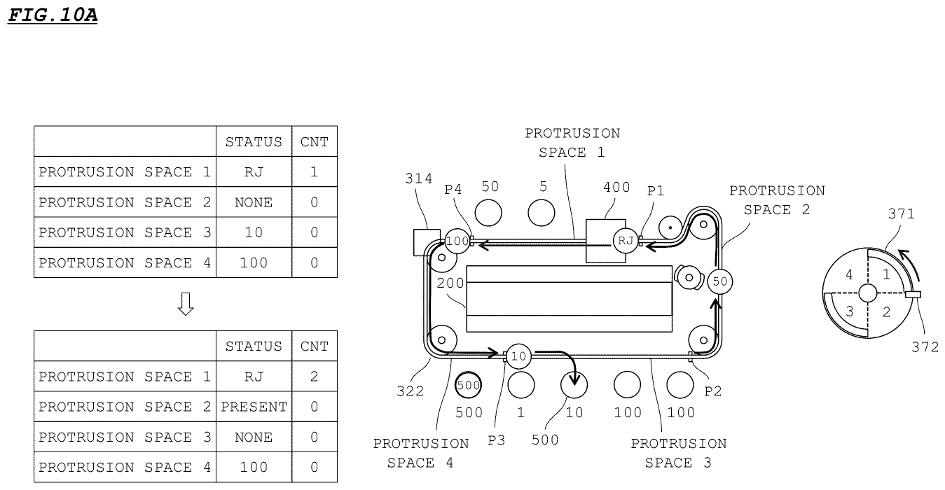

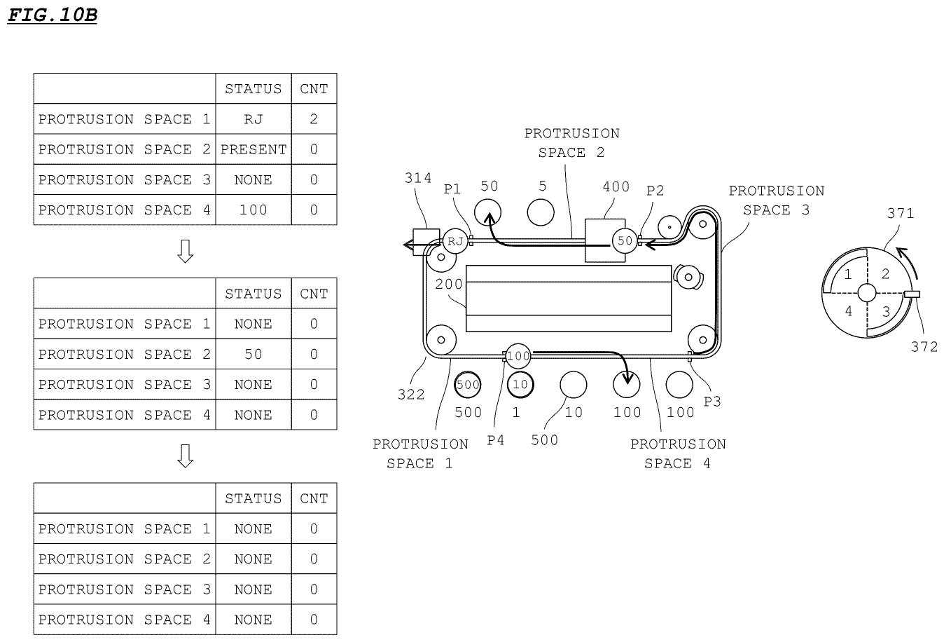

Next, as shown in FIG. 10A, the photosensor 372 detects the section 2 again. During this time, the third protrusion P3 passes through the storage unit 500 to which the 10 yen denomination is assigned, the first protrusion P1 passes through the recognition unit 400, and the second protrusion P2 passes through the payout position. The 10 yen coin in the third protrusion P3 is stored in the storage unit 500, and the status information 821 in the protrusion space 3 is updated to “none”. As a result of recognition by the recognition unit 400, the coin in the space between the protrusions P1 is again recognized as a rejected coin. The value of the count unit 811 in the protrusion space 1 becomes “2”, and the coin is determined to be a rejected coin after reaching the prescribed number of times. Since the status information 821 in the protrusion space 2 is “none”, it is determined that the second protrusion P2 is not conveying a coin. The coin is fed from the receiving unit 200 and conveyed by the second protrusion P2. The status information 821 of the protrusion space 2 is updated to “present” information.

Next, as shown in FIG. 10B, the photosensor 372 detects the section 3 again. During this time, the fourth protrusion P4 passes through the storage unit 500 to which the 100 yen denomination is assigned, the first protrusion P1 passes through the reject outlet 314, the second protrusion P2 passes through the recognition unit 400, and the third protrusion P3 passes through the feeding position. The 100 yen coin at the fourth protrusion P4 is stored in the storage unit 500, and the status information 821 for the protrusion space 4 is updated to “none”. It is determined that the coin at the first protrusion P1 is a rejected coin. Therefore, the reject outlet 314 is opened, and the rejected coin is discharged from the reject outlet 314 and returned to the dispensing outlet section 150. The status information 821 for the protrusion space 1 is updated to “none”. As a result of the recognition by the recognition unit 400, the denomination of the coin at the second protrusion P2 is recognized as 50 yen, and the status information 821 for the protrusion space 4 is updated to denomination information of “50.” The status information 821 for the protrusion space 3 is “none,” and the third protrusion P3 is not transporting coins, but since all coins have been dispensed from the receiving unit 200, no coins are being dispensed to the third protrusion P3.

Thereafter, the second protrusion P2 passes through the storage unit 500 assigned to 50 yen coins, and the 50 yen coin on the second protrusion P2 is stored in the storage unit 500. The status information 821 for the protrusion space 2 is updated to “none.” Thus, the conveyor 220 and the circulation belt 322 stop, and the deposit process is interrupted.

When a rejected coin returned to the dispensing outlet section 150 or a coin of the same denomination to replace the rejected coin is re-inserted into the receiving unit 200, the deposit process is resumed, the conveyor 220 and the circulation belt 322 start operating, and the re-inserted coin is transported to the storage unit 500 corresponding to its denomination.

In case that shown in FIG. 10A, if the coin at the first protrusion P1 is identified as a normal coin as a result of recognition by the recognition unit 400, the value of the count unit 811 in the protrusion space 1 is reset to “0”, and the status information 821 in the protrusion space 1 is updated to denomination information of the identified denomination. Thereafter, the coin at the first protrusion P1 is stored in the storage unit 500 corresponding to its denomination.

When all coins have been stored in the storage units 500 and an approval operation has been performed on the screen of the operation display unit 21 of the information terminal device 2, the cash data of each storage unit 500 stored in the memory unit 820 is updated based on the number of coins stored in each storage unit 500. In this way, the deposit process is completed.

In addition, when a return operation is performed on the screen of the operation display unit 21 of the information terminal device 2, the number of coins previously stored are dispensed from each storage unit 500, transported along the transport path 310, and returned to the dispensing outlet section 150 through the dispensing chute 600.

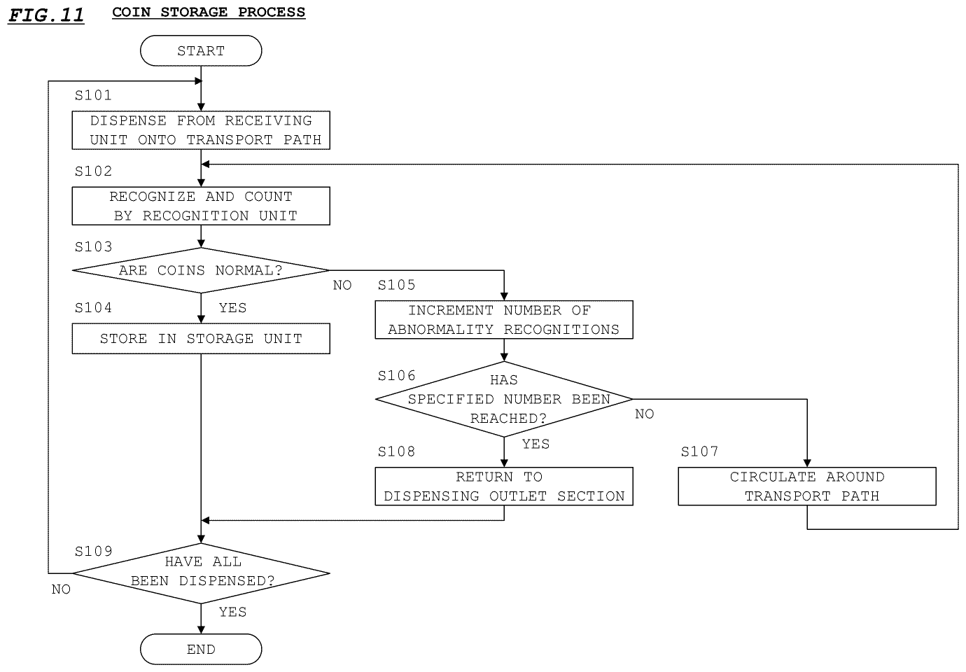

FIG. 11 is a flowchart showing the coin storage process executed by the control unit 810.

In the deposit process, the control unit 810 executes a coin storage process to store the coins inserted into the receiving unit 200 in the storage unit 500.

Referring FIG. 11, the control unit 810 dispenses coins from the receiving unit 200 onto the transport path 310 around which the circulation belt 322 rotates (S101). At this time, the control unit 810 executes a dispensing process, which will be described later, and prevents the coins from being dispensed from the receiving unit 200 if the protrusion 323 that next moves to the dispensing position is currently transporting a coin.

Next, the control unit 810 uses the recognition unit 400 to recognize the attributes of the coins flowing through the transport path 310 and counts the coins (S102). If the recognition by the recognition unit 400 determines that the coins are normal (S103: YES), the control unit 810 transports the normal coins to the storage unit 500 corresponding to their denominations and stores them therein (S104).

On the other hand, if the recognition result by the recognition unit 400 indicates that the coin is abnormal (S103: NO), the control unit 810 increments the number of times the abnormality recognition has been performed on the protrusion 323 that transports the coin, i.e., the value of the count unit 811 (S105). Then, the control unit 810 determines whether the number of times the abnormality recognition has been performed has reached a specified number (e.g., two times) (S106).

If the number of times of abnormality recognition does not reach the specified number of times (S106: NO), the control unit 810 does not determine the coin recognized as abnormal as a rejected coin, and causes the coin to circulate around the transport path 310 and reach the recognition unit 400 again (S107) without returning it to the dispensing outlet section 150. Then, the control unit 810 causes the recognition unit 400 to re-recognize the coin (S102).

If a coin that is originally normal is initially identified as abnormal by the recognition unit 400 due to a problem with the coin's posture during transport or due to a foreign object adhering to the coin, the above-mentioned defect may be corrected while the coin travels around the transport path 310. In such a case, the coin may be identified as normal as a result of re-identification. If the coin is identified as normal by re-identification by the recognition unit 400 (S103: YES), the control unit 810 stores the coin in the storage unit 500 (S104).

On the other hand, a coin that is originally abnormal may be identified as an abnormal coin even if it is re-identified. If the coin is identified as abnormal by the re-identification by the recognition unit 400 (S103: NO), the control unit 810 increments the number of abnormality recognitions (S105).

When the number of times of abnormality identification reaches a prescribed number of times (S106: YES), the control unit 810 determines the coin identified as abnormal as a rejected coin, and returns it to the dispensing outlet section 150 (S108).

The control unit 810 repeats the process of S101 to S108 until all coins have been dispensed from the receiving unit 200 (S109: NO). That is, the process of S101 to S108 is performed for each coin inserted into the receiving unit 200. Note that, in practice, the process of S101 to S108 for the next coin is started at a predetermined interval without waiting for the completion of the process of S101 to S108 for the previous coin.

When all coins have been dispensed from the receiving unit 200 (S109: YES), the control unit 810 ends the coin storage process.

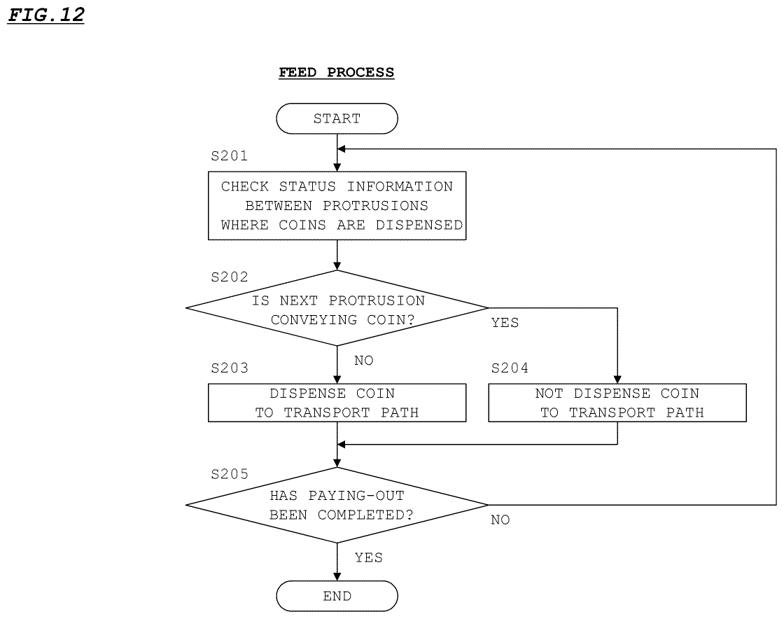

FIG. 12 is a flowchart showing the feed process executed by the control unit 810.

Referring to FIG. 12, the control unit 810 checks the status information 821 in the memory unit 820 associated with the gap between the protrusions of the circulation belt 322 along which the coins are dispensed from the receiving unit 200 (S201). Then, the control unit 810 determines whether the protrusion 323 that will next move to the coin dispense position from the receiving unit 200 is conveying a coin based on the status information 821 (S202). As described above, if the status information 821 is “none”, the coin is not being conveyed, and if the status information 821 is information other than “none”, the coin is being conveyed.

If the next moving protrusion 323 is not currently transporting a coin (S202: NO), the control unit 810 dispenses the coin from the receiving unit 200 to the transport path 310 (S203). On the other hand, if the next moving protrusion 323 is currently transporting a coin (S202: YES), the control unit 810 does not dispense the coin from the receiving unit 200 to the transport path 310 (S204). This makes it possible to prevent a new coin from being dispensed from the receiving unit 200 to a protrusion 323 that is already holding a coin.

In this manner, the control unit 810 repeats the processes of S201 to S204 each time the next protrusion 323 moves to the feeding position from the receiving unit 200 until all coins in the receiving unit 200 have been paid out (S205: NO).

The control unit 810 executes a state information update process to update the status information 821 in the memory unit 820.

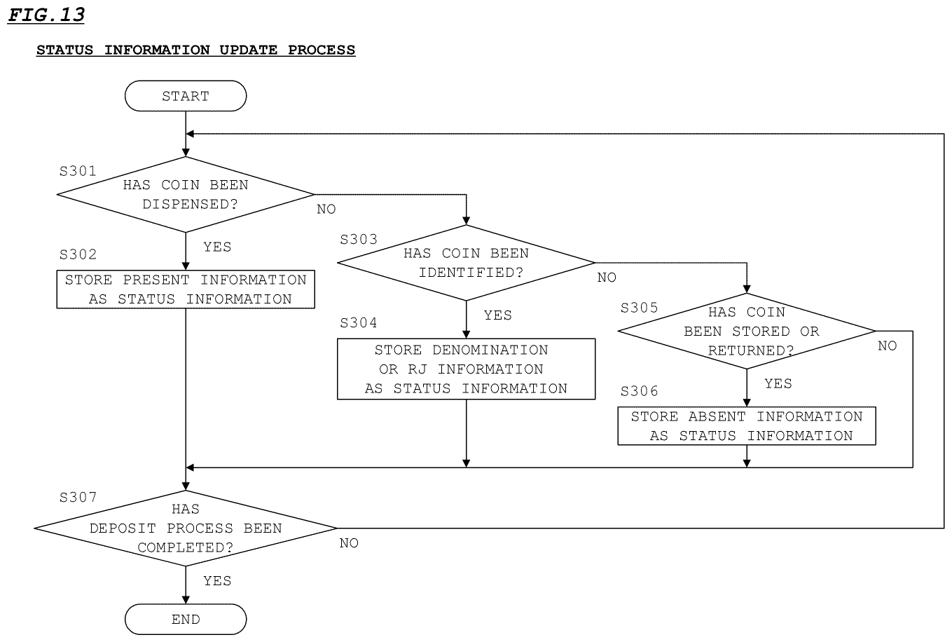

FIG. 13 is a flowchart showing the state information update process executed by the control unit 810.

Referring to FIG. 13, when the control unit 810 dispenses a coin from the receiving unit 200 (S301: YES), the control unit 810 stores “present” information in the memory unit 820 as the status information 821 associated with the target projection gap, i.e., the protrusion 323 (S302). When the control unit 810 identifies the coin using the recognition unit 400 (S303: YES), the control unit 810 stores denomination information or “RJ” information in the memory unit 820 as the status information 821 associated with the target protrusion 323 (S304). When the coin leaves the protrusion 323 and is stored in the storage unit 500 or returned to the dispensing outlet section 150 (S305: YES), the control unit 810 stores “absent” information in the memory unit 820 as the status information 821 associated with the target protrusion 323 (S306). The “present” information, denomination information and “RJ” information are information indicating that coins are being transported, and the “absent” information is information indicating that coins are not being transported.

The control unit 810 repeats the processes of S301 to S306 until the deposit process is completed (S307: NO).

### <Replenishment Process>

In the replenishment process, coins to be replenished are inserted into the receiving unit 200 and transported from the receiving unit 200 to the storage unit 500 to be replenished. Thus, in the replenishment process, the control unit 810 executes the coin storage process shown in FIG. 11, the payout process shown in FIG. 12, and the status information update process shown in FIG. 13, similar to the deposit process.

### <Dispensing Process>

If the amount of coins accepted during the deposit process is greater than the fee amount and change is required in coins, a dispensing process is executed.

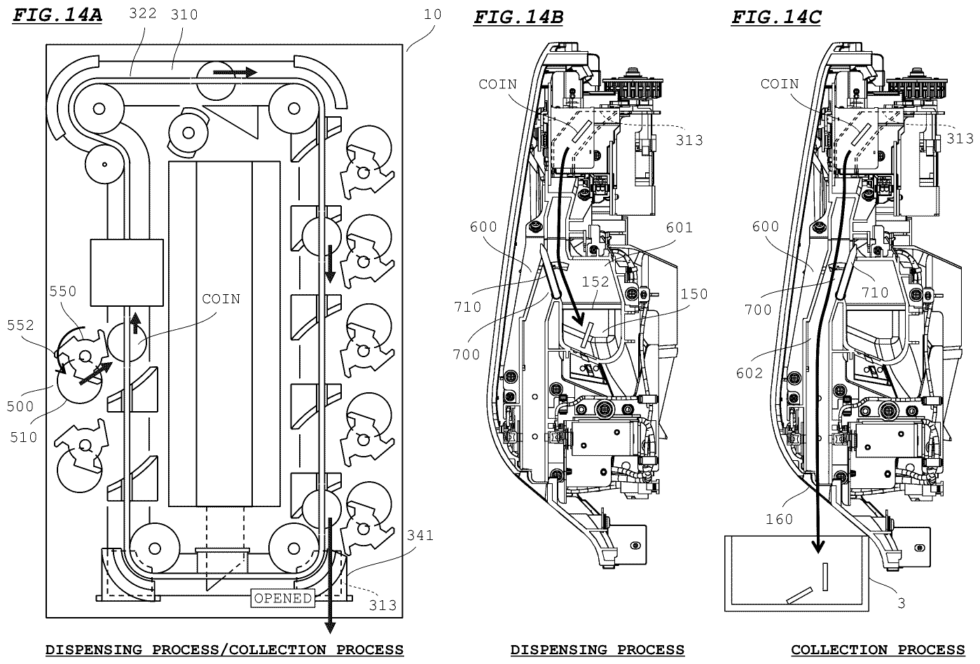

FIGS. 14A and 14B are diagrams for explaining the payout process.

When the dispensing process is started, the path switching unit 700 switches the path of the dispensing chute 600 so that it leads to the dispensing outlet section 150, as shown in FIG. 14B.

Next, coins are started to be fed from the storage unit 500 and conveyed to the dispensing outlet 313. As shown in FIG. 14A, coins of the denomination to be given as change are fed from the corresponding storage unit 500 to the transport path 310. At this time, the cam 550 rotates counterclockwise, and the coins that have come out of the housing 510 are pushed by the protrusion 552 of the cam 550 and move to the transport path 310. The circulation belt 322 rotates clockwise, and the coins fed from the storage unit 500 are conveyed clockwise along the transport path 310 toward the dispensing outlet 313. At this time, the control unit 810 opens the diverting member 341, so that the dispensing outlet 313 is opened. As a result, the coins are discharged from the dispensing outlet 313.

As shown in FIG. 14B, coins discharged from the dispensing outlet 313 fall down the dispensing chute 600 and are discharged from the dispensing outlet 152 into the dispensing outlet section 150. The discharged coins are accumulated in the tray 151.

When the change amount of coins has been dispensed to the dispensing outlet section 150, the feeding of coins from the storage unit 500 and the transport of coins to the dispensing outlet 313 are stopped. In this manner, the dispensing process is completed.

### <Collection Processing>

When it becomes necessary to collect coins from the storage unit 500, the collection process is performed when the coin processing device 1 is not being used by customers, such as outside business hours.

FIG. 14C is a diagram for explaining the collection process.

When starting the collection process, an attendant prepares a collection container 3 with a larger capacity than the tray 151 of the dispensing outlet section 150, and inserts the collection container 3 under the third surface 131c on the front surface 131 of the coin processing device 1 and places it below the collection outlet section 160.

When the collection process is started, the path switching unit 700 switches the path of the dispensing chute 600 so that it leads to the collection outlet section 160, as shown in FIG. 14C.

Next, the process starts to feed out coins from the storage unit 500 and transport the coins to the dispensing outlet 313. As in the case of the dispensing process, the coins fed from the target storage unit 500 are transported along the transport path 310 and discharged from the dispensing outlet 313 (see FIG. 14A).

As shown in FIG. 14C, coins discharged from the dispensing outlet 313 fall down the dispensing chute 600 and are discharged directly below from the collection outlet section 160. The discharged coins are accumulated in the collection container 3.

When all of the collected coins have been discharged from the collection outlet section 160, the feeding of coins from the storage unit 500 and the transport of coins to the dispensing outlet 313 are stopped. In this way, the collection process is completed.

### <Reconciliation Processing>

The reconciliation process may be performed, for example, during a time period when the coin processing device 1 is not used by customers or is less likely to be used by customers. During the reconciliation process, the receiving unit 200 functions as a reconciliation storage unit to which coins from the storage unit 500 are transferred.

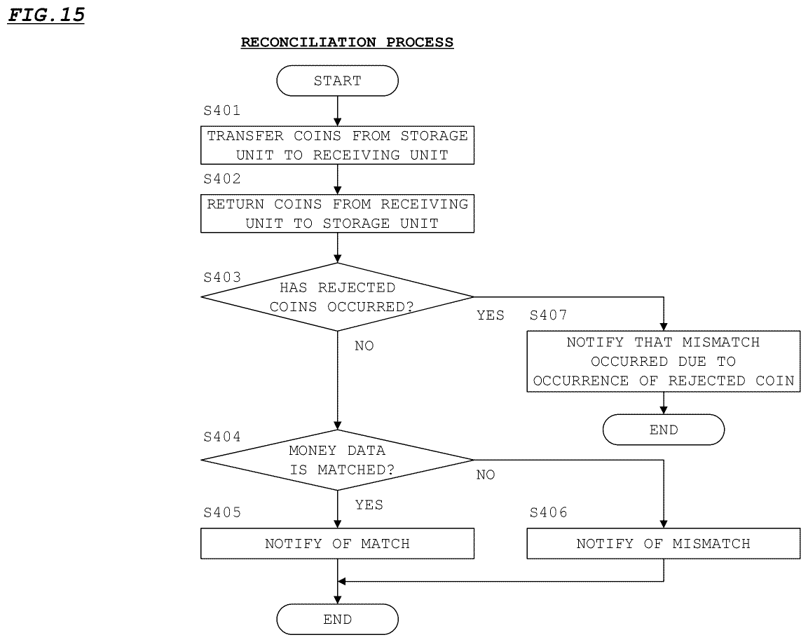

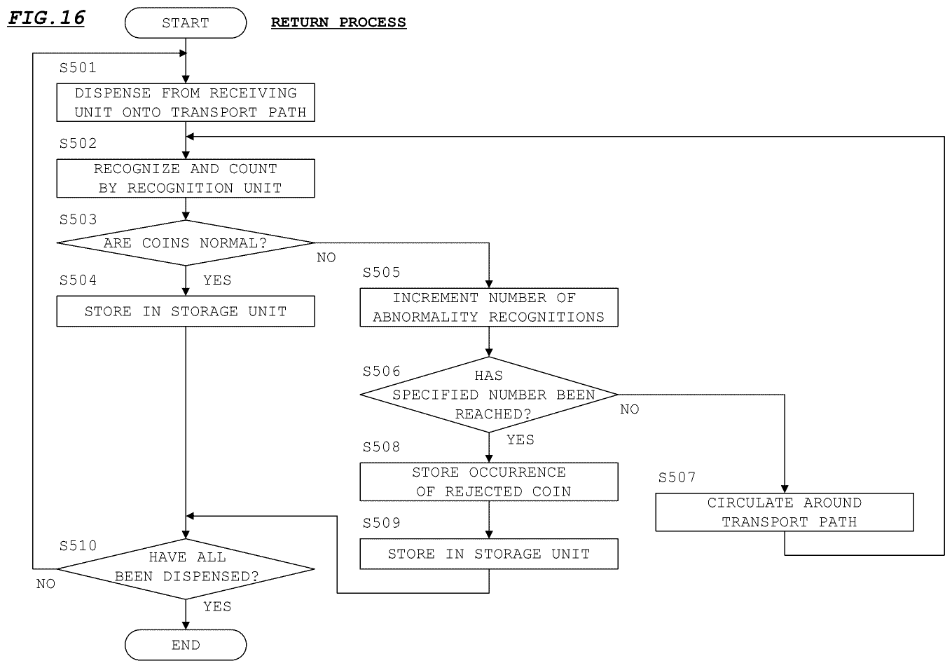

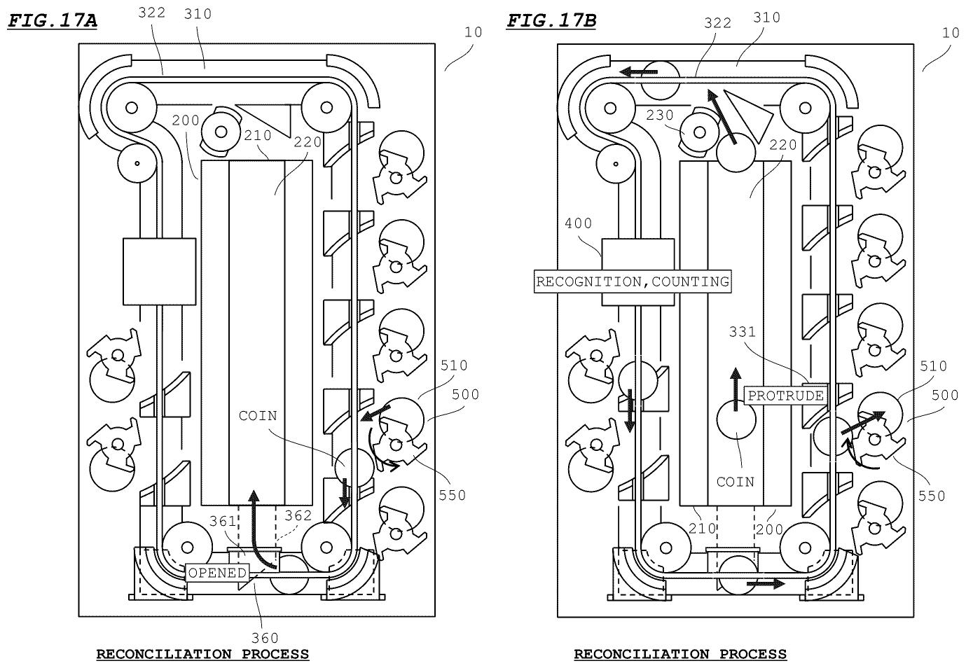

FIG. 15 is a flowchart showing a control process executed by the control unit 810 for the reconciliation process. FIG. 16 is a flowchart showing a return process executed by the control unit 810 when returning coins from the receiving unit 200 to the storage unit 500 in the reconciliation process. FIGS. 17A and 17B are diagrams for explaining the reconciliation process.

Referring to FIG. 15, when the reconciliation process is started, the control unit 810 operates the storage unit 500 and the transport unit 300 to transfer all coins in the storage unit 500 to the receiving unit 200 (S401).

As shown in FIG. 7A, the coins in the storage unit 500 to be inspected are fed out one by one to the transport path 310 by the rotation of the cam 550. The circulation belt 322 rotates clockwise, and the coins fed out from the storage unit 500 are conveyed clockwise along the transport path 310 toward the hopper diverting mechanism 360. At this time, the control unit 810 opens the diverting member 361, thereby opening the entrance of the chute 362. As a result, the coins enter the chute 362, pass through the chute 362, and are stored in the hopper 210 of the receiving unit 200.

Next, the control unit 810 operates the receiving unit 200, the transport unit 300 and the storage unit 500 to return all coins in the receiving unit 200 to the original storage unit 500 (S402).

As shown in FIG. 17B, coins stored in the hopper 210 are sent by the conveyor 220 and fed out to the transport path 310 by the feeding cam 230. The circulation belt 322 rotates counterclockwise, and the coins are transported counterclockwise along the transport path 310 toward the original storage unit 500. The diverting member 331 corresponding to the original storage unit 500 protrudes into the transport path 310, and the cam 550 rotates clockwise. The coins are pushed by the cam 550 while being guided by the diverting member 331, and are sent to the housing 510 of the storage unit 500. On the way back to the storage unit 500 from the receiving unit 200, the coins pass through the recognition unit 400, which recognizes and counts the coins.

When returning coins from the receiving unit 200 to the storage unit 500, the control unit 810 executes return processing in FIG. 16. That is, the control unit 810 feeds coins from the receiving unit 200 onto the transport path 310 around which the circulation belt 322 rotates (S501), identifies the attributes of the coins flowing through the transport path 310 by the recognition unit 400, and counts the coins (S502). Then, if the coins are normal as a result of the recognition by the recognition unit 400 (S503: YES), the control unit 810 transports the normal coins to the original storage unit 500 and stores them (S504).

On the other hand, if the recognition result by the recognition unit 400 indicates that the coin is abnormal (S503: NO), the control unit 810 increments the number of times the abnormality recognition has been performed on the protrusion 323 that transports the coin, i.e., the value of the count unit 811 (S505). Then, the control unit 810 determines whether the number of times the abnormality recognition has been performed has reached a specified number (e.g., two times) (S506).

If the number of times of abnormality recognition does not reach the specified number of times (S506: NO), the control unit 810 does not determine the coin recognized as abnormal as a rejected coin, but causes the coin to circulate around the transport path 310 and reach the recognition unit 400 again (S507). Then, the control unit 810 causes the recognition unit 400 to re-recognize the coin (S502).

If the coin is recognized as normal by the re-identification in the recognition unit 400 (S503: YES), the control unit 810 stores the coin back in the storage unit 500 (S504). On the other hand, if the coin is recognized as abnormal by the re-identification in the recognition unit 400 (S503: NO), the control unit 810 increments the number of abnormality recognitions (S505).

When the number of abnormality identifications reaches a specified number (S506: YES), the control unit 810 determines that the coin identified as abnormal is a rejected coin, stores the fact that a rejected coin has occurred in the memory unit 820 (S508), and stores the rejected coin in the original storage unit 500 (S509).

The control unit 810 repeats the process of S501 to S509 until all coins have been dispensed from the receiving unit 200 (S510: NO). In reality, the process of S501 to S509 for the next coin is started at a predetermined interval without waiting for the completion of the process of S501 to S509 for the previous coin.

When all coins have been dispensed from the receiving unit 200 (S510: YES), the control unit 810 ends the return process.

After one coin is determined to be a rejected coin and the occurrence of the rejected coin is stored in the memory unit 820, even if a new coin is identified as abnormal in S503, the control unit 810 does not perform the processes of S505 to S508 for that coin, and stores the coin in the original storage unit 500. As a result, after the rejected coin is determined, the coin does not have to be circulated for re-identification, and the time required to store the coin in the original storage unit 500 is shortened.

Returning to FIG. 15, when all coins are returned from the receiving unit 200 to the storage unit 500, the control unit 810 judges whether or not the occurrence of rejected coins is stored in the memory unit 820 (S403). If the occurrence of rejected coins is not stored (S403: NO), the control unit 810 judges whether or not the counting result by the recognition unit 400, i.e., the amount of coins in the storage unit 500, matches the amount data stored in the memory unit 820 (S404).

If the counting result matches the money data (S404: YES), the control unit 810 notifies the operation display unit 21 of the information terminal device 2 that there is a match (S405), and if the counting result does not match the money data (S404: NO), the control unit 810 notifies the operation display unit 21 of a mismatch (S406).

On the other hand, if the occurrence of a rejected coin is stored in the memory unit 820 (S403: YES), the control unit 810 notifies via the operation and display unit 21 that the occurrence of a rejected coin has caused the amount of coins in the storage unit 500 to differ from the amount data.

In this way, the reconciliation process is completed. Similarly, the reconciliation process is performed on the other storage units 500 to be reconciled.

In addition, the advance process in FIG. 12 and the state information update process in FIG. 13 are executed in parallel with the return process in FIG.

In the storage unit 500 where the rejected coin occurred, a reconciliation process is carried out in the presence of an attendant. In this reconciliation process, when coins are returned from the receiving unit 200 to the storage unit 500, any coins that are identified as abnormal by the recognition unit 400 are immediately determined to be rejected coins and returned to the dispensing outlet section 150. This allows the attendant to remove the returned rejected coins from the dispensing outlet section 150 and check them.

According to the present disclosure, the following effects can be achieved. In a coin storage process in which coins received by the receiving unit 200 are stored in the storage unit 500, money that is recognized as abnormal by the recognition unit 400 is circulated around the transport path 310 and re-recognized at least once by the recognition unit 400, and the money is returned to the dispensing outlet section 150 based on the result of the re-recognition.

This makes it easier for coins that are originally normal to be identified as normal coins through re-identification, and easier for them to be stored in the storage unit 500. This makes it harder for rejected coins to be returned to the dispensing outlet section 150.

Furthermore, a coin that is identified as abnormal by the recognition unit 400 and has been identified as abnormal multiple times, which is less than the specified number of times, is re-identified by the recognition unit 400, and a coin whose abnormality recognition count reaches the specified number of times is returned to the dispensing outlet section 150. In this way, a coin that is originally abnormal can be returned to the dispensing outlet section 150 when the abnormality recognition count reaches the specified number of times.

Furthermore, in the reconciliation process, when coins are returned from the receiving unit 200 to the storage unit 500, coins that have been identified as abnormal by the recognition unit 400 are circulated around the transport path 310 and re-identified by the recognition unit 400. This makes it easier for coins that are actually normal to be identified as normal through re-identification, making it less likely that inconsistencies in the cash inventory data caused by rejected coins will occur. This makes it possible to reduce the frequency with which the reconciliation process needs to be performed again.

Furthermore, if the re-identification by the recognition unit 400 determines that the coin identified as abnormal is a rejected coin, a notification is given that the amount of coins in the storage unit 500 does not match the amount data due to the occurrence of the rejected coin. This allows staff etc. to understand that a mismatch with the amount data has occurred due to the occurrence of the rejected coin.

Furthermore, when a coin is dispensed from the receiving unit 200 to the protrusion 323 while the circulation belt 322 is rotating, information indicating that the coin is being conveyed is stored in the memory unit 820 as the status information 821, and when the coin being conveyed by the protrusion 323 is separated from the protrusion 323, information indicating that the coin is not being conveyed is stored in the memory unit 820 as the status information 821. Then, the receiving unit 200 is controlled to dispense the coin to the protrusion 323 that is determined not to be conveying the coin based on the status information 821. This makes it possible to prevent the receiving unit 200 from newly dispensing a coin to the protrusion 323 that is already holding a coin. Moreover, it is not necessary to arrange a sensor for detecting whether the protrusion 323 is holding a coin or not near the receiving unit 200 on the transport path 310.

Although embodiments of the disclosure has been described above, the disclosure is not limited to the above embodiments, and various modifications of the embodiments of the disclosure are possible.

### <Modification 1>

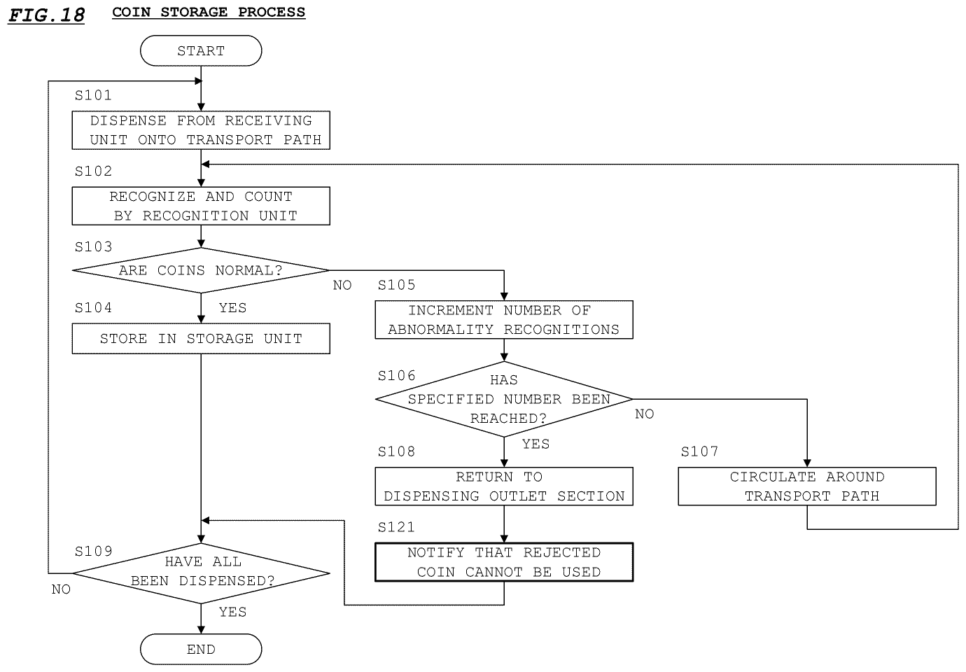

FIG. 18 is a flowchart showing the coin storage process executed by the control unit 810 according to the first modified example.

As shown in FIG. 18, in this Modification Example 1, the control unit 810 determines the coin identified as abnormal as a rejected coin based on the fact that the number of abnormality identifications has reached a specified number, and after returning the coin to the dispensing outlet section 150, performs a notification process to notify the user that the returned rejected coin cannot be used (S121). For example, as the notification process, the control unit 810 causes the operation display unit 21 of the information terminal device 2 to display a screen including a message such as “This coin cannot be used”. As the notification process, the control unit 810 may output the sound of the message from the sound output unit 830. Furthermore, a display unit may be provided in the coin processing device 1, and the display unit may display a message that the returned rejected coin cannot be used.

This makes it easier for users to quickly prepare coins of the same denomination to replace the rejected coins and re-insert them into the coin processing device 1.

### <Modification 2>

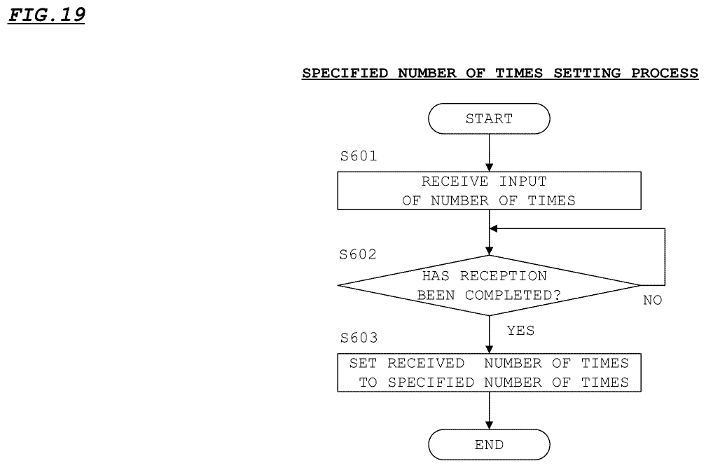

FIG. 19 is a flowchart showing a specified number of times setting process executed by the control unit 810 according to the second modification.

In this modified example, an attendant or the like can set the number of re-identifications to be performed by the recognition unit 400 before the coin is returned to the dispensing outlet section 150 as a rejected coin by setting the specified number of times used in the judgment in S106 of the coin storage process in FIG. 11 to the desired number.

Referring to FIG. 19, the control unit 810 receives input of the number of times to be the specified number of times (S601). At this time, the operation display unit 21 of the information terminal device 2 is an input interface and may function as an input unit, and the number of times is input via a setting screen displayed on the operation display unit 21. The input number of times is transmitted from the information terminal device 2 to the control unit 810. When the control unit 810 has completed receiving the number of times (S602: YES), it sets the received number of times to the specified number of times (S603).

The coin processing device 1 may be provided with an input unit such as a touch panel, and the number of times may be input into the input unit.

### <Modification 3>

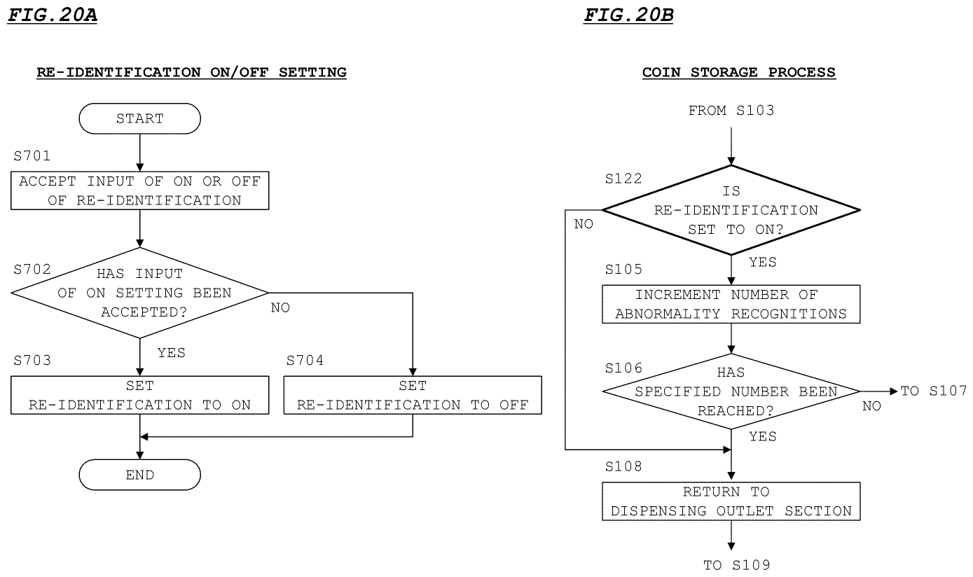

FIG. 20A is a flowchart showing a re-identification on/off setting process executed by the control unit 810 according to Modification Example 3. FIG. 20B is a flowchart showing a coin storage process executed by the control unit 810 according to Modification Example 3. For convenience, FIG. 20B shows only a part of the processes in the coin storage process.

In this modified example, an attendant or the like can set whether or not to re-identify coins that have been identified as abnormal in the coin storage process of FIG. 11.

Referring to FIG. 20A, the control unit 810 accepts a setting of either an on setting or an off setting of re-identification by the recognition unit 400 (S701). At this time, the operation display unit 21 of the information terminal device 2 functions as an input unit, and an on setting or an off setting is input via a setting screen displayed on the operation display unit 21, and the setting result is transmitted from the information terminal device 2 to the control unit 810. When the control unit 810 accepts an on setting (S702: YES), it sets re-identification to on (S703), and when it accepts an off setting (S702: NO), it sets re-identification to off (S704).

Referring to FIG. 20B, when the recognition unit 400 recognizes a coin as abnormal (S103: NO), the control unit 810 determines whether or not re-identification is set to ON (S122). When re-identification is set to ON (S122: YES), the control unit 810 increments the number of times the coin has been recognized as abnormal (S105) and determines whether or not the number of times the coin has been recognized as abnormal has reached a specified number (S106). On the other hand, when re-identification is set to OFF (S122: NO), the control unit 810 skips the processes of S105 and S106, and immediately determines the coin recognized as abnormal as a rejected coin and returns it to the dispensing outlet section 150 (S108).

In this way, when the control unit 810 receives an on setting, it causes the coins identified as abnormal by the recognition unit 400 to circulate around the transport path 310 and be re-identified by the recognition unit 400, and when it receives an off setting, it causes the coins identified as abnormal by the recognition unit 400 to be returned to the dispensing outlet section 150 without being re-identified by the recognition unit 400.

According to this modification, it is possible to determine whether or not to re-identify a coin that has been identified as abnormal, depending on the application of the coin processing device 1. For example, it is possible to set the coin processing device 1 to perform re-identification when a customer himself deposits money into the coin processing device 1.

The coin processing device 1 may be provided with an input unit such as a touch panel, and an on or off setting may be input to the input unit.

### <Modification 4>

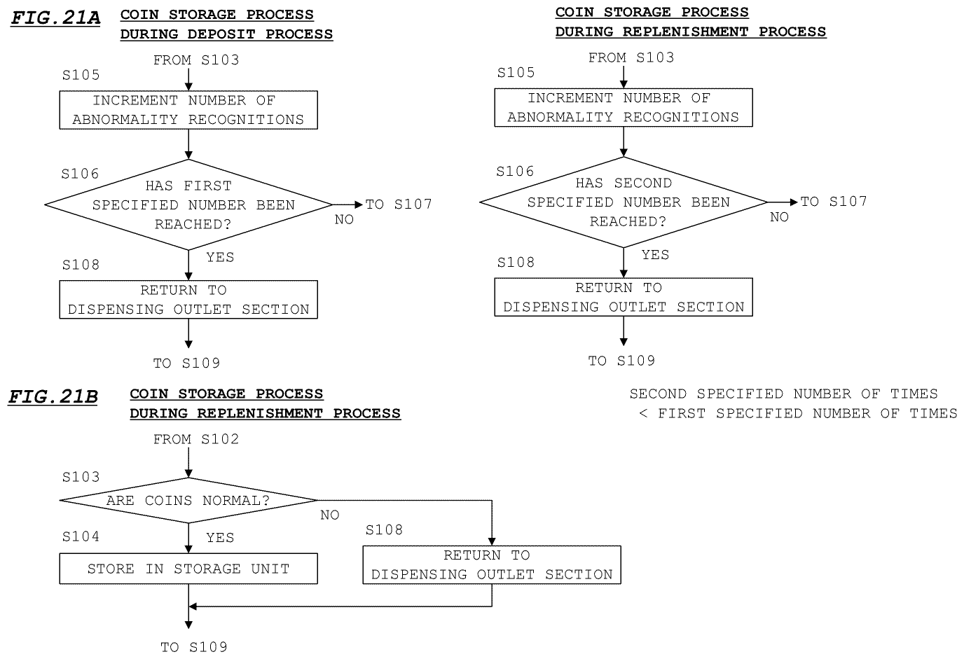

FIG. 21A is a flowchart showing a coin storing process executed during a deposit process and a coin storing process executed during a replenishment process, according to Modification Example 4. For convenience, FIG. 21A shows only a part of the coin storing process.

Since the replenishment process is performed by a staff member who is familiar with the operation, the time required is not likely to be long even if rejected coins are returned, compared to the deposit process performed by a customer. Therefore, the specified number of times used for the judgment in S106 of the coin storage process in FIG. 11 can be made smaller in the replenishment process than in the deposit process.

Therefore, as shown in FIG. 21A, in this modified example, in S106 of the coin storage process during the deposit process, the control unit 810 determines whether the number of times that abnormality is identified as abnormal has reached a first specified number of times (e.g., 3 times), which is a number of times. On the other hand, in S106 of the coin storage process during the replenishment process, the control unit 810 determines whether the number of times that abnormality is identified as abnormal has reached a second specified number of times (e.g., 2 times), which is a number of times and is less than the first specified number.

According to this modified example, it is easy to optimize the number of times that the recognition unit 400 needs to recognize a coin that has been recognized as abnormal before it is returned, depending on whether the process being performed is a deposit process or a replenishment process.

### <Modification 5>

FIG. 21B is a flowchart showing a coin storing process executed during a replenishment process according to Modification Example 5. For the sake of convenience, FIG. 21B shows only a part of the coin storing process.

As described above, the time required for the replenishment process is less likely to be long even if rejected coins are returned, compared to the deposit process. Therefore, as shown in FIG. 21B, in the coin storage process during the replenishment process, in this modified example, the control unit 810 immediately determines that the money recognized as abnormal by the recognition unit 400 is a rejected coin, and returns it to the dispensing outlet section 150 without having the recognition unit 400 recognize it again (S103: NO→S108).

According to this modified example, it is easy to optimize the number of times that the recognition unit 400 needs to recognize a coin that has been recognized as abnormal before it is returned, depending on whether the process being performed is a deposit process or a replenishment process.

### <Modification 6>

In the above embodiments, in the dispensing process, coins fed from the storage unit 500 are transported along the transport path 310 and then discharged through the dispensing outlet 313 and the dispensing chute 600 to the dispensing outlet section 150.

In the sixth modified example, in the dispensing process, coins from the storage unit 500 are temporarily stored in the hopper 210 of the receiving unit 200, and the coins stored in the hopper 210 are discharged to the dispensing outlet section 150 all at once.

In the dispensing process, it is preferable to be able to select whether to use the route via the dispensing chute 600 or the route via the hopper 210.

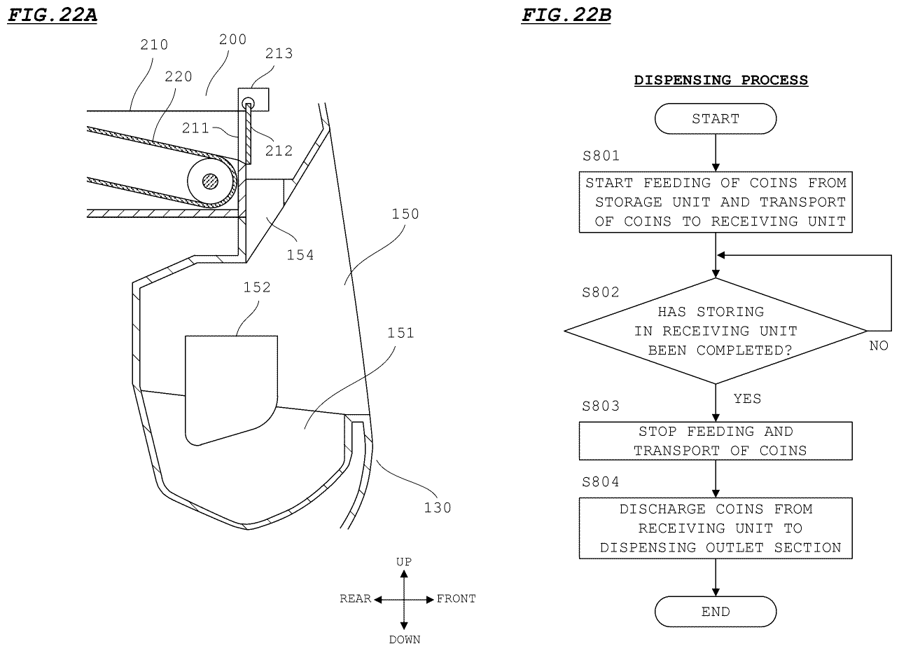

FIG. 22A is a cross-sectional view showing the configuration of the dispensing outlet section 150 and the receiving unit 200 according to the sixth modified example.

As shown in FIG. 22A, in the receiving unit 200, a dispensing outlet 211 is provided on the front surface of a hopper 210. The dispensing outlet 211 is closed from the front by a lid 212. The lid 212 is opened and closed by an opening/closing device 213 including a drive source. A chute 154 extending upward is formed at the upper end of the dispensing outlet section 150. The entrance of the chute 154 is located in front of and below the dispensing outlet 211.

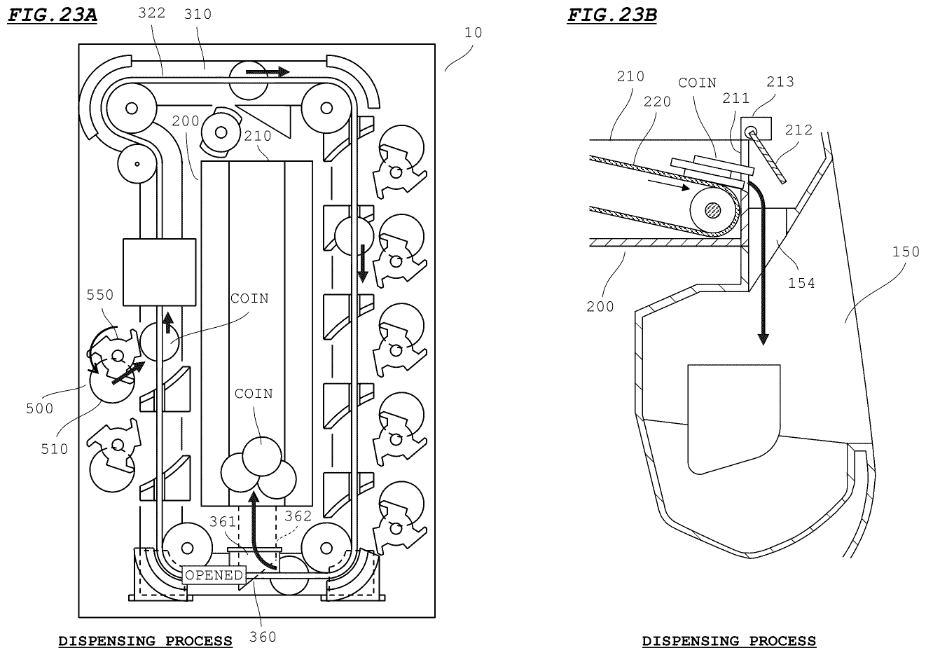

FIG. 22B is a flowchart showing a control process executed by the control unit 810 in the payout process according to Modification Example 6. FIGS. 23A and 23B are diagrams for explaining the payout process according to Modification Example 6.

FIG. 22B, when the dispensing process is started, the control unit 810 starts the operation of the storage unit 500 and the transport unit 300, and starts the feeding of coins from the storage unit 500 and the transport of the coins to the receiving unit 200 (S801). As shown in FIG. 23A, coins for change are fed from the storage unit 500 and flow through the transport path 310, and are sorted by the hopper diverting mechanism 360 and stored in the hopper 210 of the receiving unit 200.

When the change amount of coins is received in the hopper 210 of the receiving unit 200 (S802: YES), the control unit 810 stops the operation of the storage unit 500 and the transport unit 300, and stops the feeding of coins from the storage unit 500 and the transport of coins to the receiving unit 200 (S803).

Next, the control unit 810 causes the coins to be discharged from the receiving unit 200 to the dispensing outlet section 150 (S804). That is, the control unit 810 causes the opening/closing device 213 to open the lid 212 to open the dispensing outlet 211, and causes the conveyor 220 to rotate toward the front dispensing outlet 211 side. As shown in FIG. 23B, the coins stored in the hopper 210 are released all at once into the dispensing outlet section 150 through the dispensing outlet 211 and the chute 154. In this way, the payout process is completed.

If it takes a long time for coins to finish being dispensed from the time they start to be dispensed through the dispensing outlet section 150, customers are likely to forget to take the coins. In this regard, according to this modified example, coins as change are dispensed all at once through the dispensing outlet section 150, making it less likely that customers will forget to take the coins.

### <Modification 7>

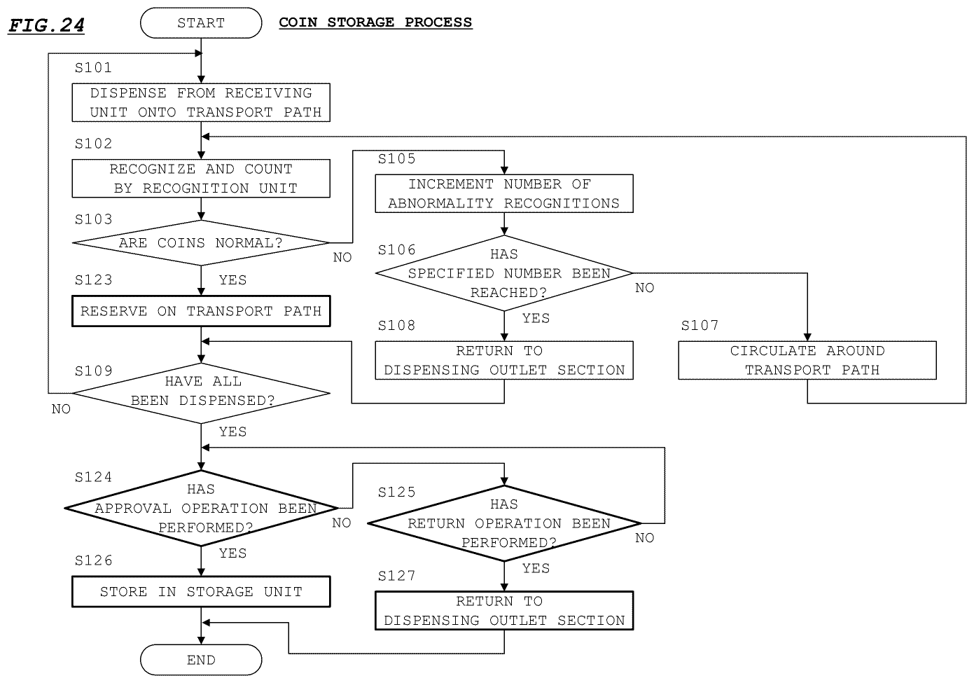

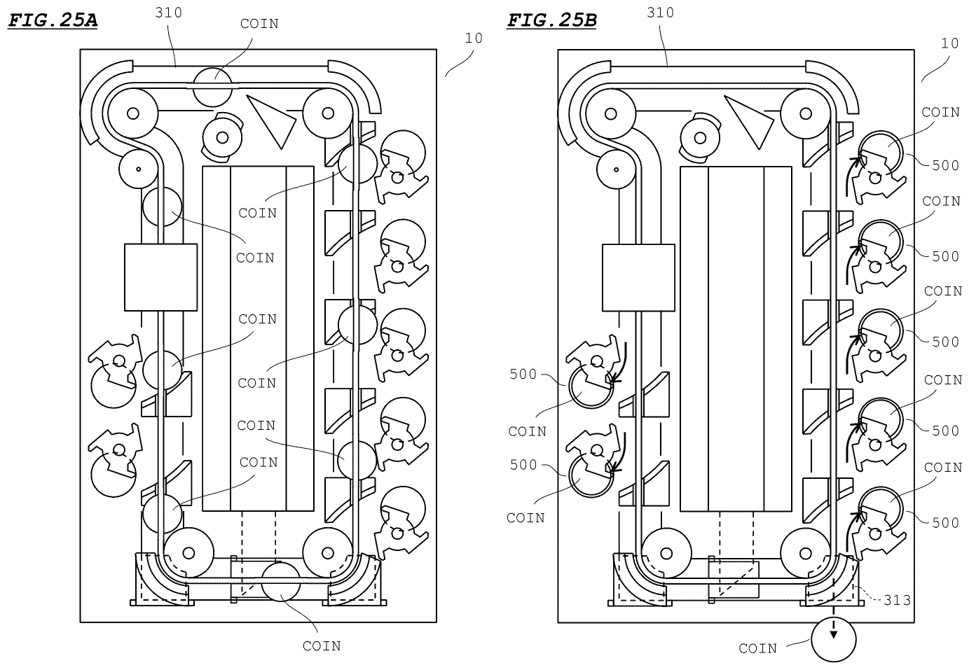

FIG. 24 is a flow chart showing the coin storage process executed by the control unit 810 during a deposit process according to Modification Example 7. FIGS. 25A and 25B are diagrams for explaining the coin storage process during a deposit process according to Modification Example 7. In the coin storage process shown in FIG. 24, the same processes as those in the coin storage process shown in FIG. 11 are assigned the same step numbers.

In this modified example, in the deposit process, the coin storage process of this Modification Example can be executed when the number of coins deposited is less than the number of protrusions 323 of the circulation belt 322. In this modified example, the transport path 310 functions as a temporary storage section, and the deposited coins are temporarily stored in the transport path 310 before being stored in the storage unit 500.

In a deposit process, when a small amount of coins are inserted into the receiving unit 200, the control unit 810 starts the coin storage process shown in FIG. 24.

The control unit 810 uses the recognition unit 400 to recognize coins that are fed from the receiving unit 200 and flow through the transport path 310 (S101, S102). If the control unit 810 recognizes a coin as normal (S103: YES), it reserves the coin on the transport path 310 without storing it in the storage unit 500 (S123). On the other hand, if the control unit 810 recognizes a coin as abnormal (S103: NO), it circulates the coin along the transport path 310 and has it re-recognized by the recognition unit 400 (S105 to S107, S102), and when the number of times the coin has been recognized as abnormal reaches a specified number (S103 to S106), it returns the coin to the dispensing outlet section 150 (S108).

As shown in FIG. 25A, all coins dispensed from the receiving unit 200 are held on the transport path 310.

When all the coins have been dispensed from the receiving unit 200, the control unit 810 waits for the customer to perform an approval operation or a return operation on the operation display unit 21 of the information terminal device 2 (S124, S125). At this time, the control unit 810 may allow the transport unit 300 to continue or stop the circulation of the coins on the transport path 310.

When an approval operation is performed (S124: YES), the control unit 810 stores each coin reserved in the transport path 310 in the storage unit 500 corresponding to the respective denomination, as shown by the solid arrow in FIG. 25B (S126). On the other hand, when a return operation is performed (S125: YES), the control unit 810 discharges each coin reserved in the transport path 310 from the dispensing outlet 313 and returns it to the dispensing outlet section 150, as shown by the dashed arrow in FIG. 25B (S127).

According to this modification, the transport path 310 can be utilized as a temporary storage section for temporarily storing coins. As a result, when a return operation is performed, the coins can be returned to the dispensing outlet section 150 in a shorter time than when coins already stored in the storage unit 500 are returned.

### <Modification 8>

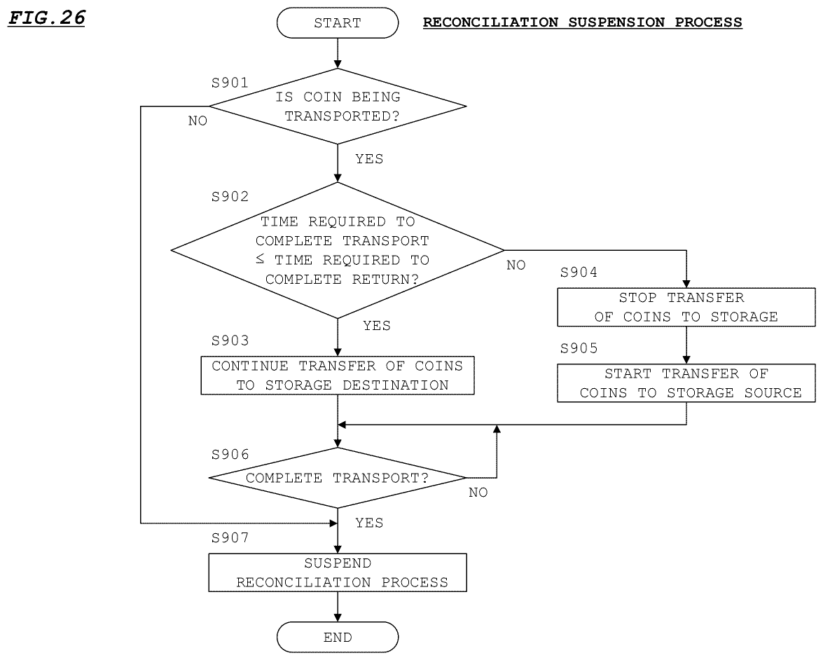

FIG. 26 is a flowchart showing the reconciliation suspension process executed by the control unit 810 according to the eighth modification.

For example, if the reconciliation process is performed during business hours when the coin processing device 1 is unlikely to be used by customers, it is assumed that a customer will use the coin processing device 1 while the reconciliation process is being performed, and a deposit process will be performed by interruption. In this case, the reconciliation process is suspended before the deposit process is interrupted, and at this time, it is desirable to suspend the reconciliation process early even if coins are in the process of moving between the storage unit 500 and the receiving unit 200, which is the storage unit for reconciliation.

Therefore, in this modified example, the control unit 810 executes the reconciliation suspension process shown in FIG. 26 in parallel with the reconciliation process shown in FIG. 15. When it becomes necessary to interrupt another transaction process, such as a deposit process, an instruction to suspend the reconciliation is given to the control unit 810 from the information terminal device 2, for example. Upon receiving the instruction to suspend the reconciliation, the control unit 810 starts the reconciliation suspension process.

Referring to FIG. 26, the control unit 810 judges whether or not a coin is being transported from a storage source to a storage destination (S901). When a coin is being transferred from the storage unit 500 to the receiving unit 200, the storage unit 500 is the storage source and the receiving unit 200 is the storage destination. When a coin is being returned from the receiving unit 200 to the storage unit 500, the receiving unit 200 is the storage source and the storage unit 500 is the storage destination.

If the control unit 810 is not transporting coins (S901: NO), it immediately suspends the reconciliation process (S907). On the other hand, if the control unit 810 is transporting coins (S901: YES), it determines which of the time required to transport all coins to the storage destination (referred to as the “time required to complete transport”) and the time required to return all coins from the storage destination to the storage source (referred to as the “time required to complete return”) is shorter (S902).

For example, the control unit 810 compares the number of coins stored at the storage source and the storage destination, and when the number of coins stored at the storage source is smaller, it considers the time required to complete the transport to be shorter than the time required to complete the return, and when the number of coins stored at the storage destination is smaller, it considers the time required to complete the return to be shorter than the time required to complete the transport. Note that the control unit 810 may determine the length of the required transport completion time and the required return completion time by considering the length of the transport path from the transport to the storage destination and the transport path from the transport destination to the storage source.

If the required time for completing the transfer is equal to or less than the required time for completing the return (S902: YES), the control unit 810 continues the transfer of the coins to the storage destination (S903). On the other hand, if the required time for completing the return is shorter than the required time for completing the transfer (S902: NO), the control unit 810 stops the transfer of the coins to the storage destination (S904) and starts the transfer of the coins to the storage source (S905). Then, when the transfer of the coins is completed (S906: YES), the control unit 810 suspends the reconciliation process (S907). In this way, the reconciliation suspension process ends.

According to this modification, when it becomes necessary to suspend the reconciliation process, it can be suspended quickly.

### <Other Changes>

In the above embodiments, in the coin storage process, the coins identified as normal by the recognition unit 400 are stored in the storage unit 500. However, the storage unit 500 closest to the recognition unit 400 among the seven storage units 500, i.e., the storage unit 500 furthest upstream in the coin transport direction during the deposit process, may be made to function as a temporary storage unit, so that the coins identified as normal by the recognition unit 400 are stored in the temporary storage unit. In this case, when an approval operation is performed after the storage of the coins in the temporary storage units is completed, the coins in the temporary storage units are transported to the storage units 500 corresponding to the respective denominations. Also, any of the seven storage units 500 may be made to function as an overflow collection unit, and when a coin identified as normal by the recognition unit 400 cannot be stored in the storage unit 500 corresponding to the denomination of the coin because the storage unit 500 corresponding to the denomination of the coin is full, the coin may be stored in the overflow collection unit. In these cases, the temporary holding section and the overflow collection section, like the storage unit 500, serve as currency storage units in which coins as currency are stored.

Furthermore, in the above embodiments, the dispensing outlet section 150 also functions as a return port for returning rejected coins. However, the coin processing device 1 may be provided with a dedicated return port for returning rejected coins.

Furthermore, in the above embodiments, the receiving unit 200 is used as the reconciliation storage section during the reconciliation process. However, one of the seven storage units 500 may be assigned to the reconciliation storage section, or a dedicated reconciliation storage section may be provided in the coin processing unit 10.

Furthermore, in the above embodiments, in the reconciliation process, the recognition unit 400 recognizes the coins in the process of moving the coins from the storage unit 500 to the receiving unit 200. However, the recognition unit 400 may recognize the coins in the process of returning the coins from the receiving unit 200 to the storage unit 500.

Furthermore, in the above embodiments, when a coin is identified as an abnormal coin by the recognition unit 400, the count unit 811 counts the coin. That is, the count unit 811 counts the number of times the coin is identified as abnormal. However, the count unit 811 may simply count the number of times the coin is identified. In this case, when a coin is not identified as abnormal and is stored in the storage unit 500 without rotating along the transport path 310 once, the value of the count unit 811 for that coin is reset. Therefore, when the value of the count unit 811 reaches the specified number of times, the number of abnormality identifications in which the coin has been identified as abnormal will also reach the specified number of times.

Furthermore, the present disclosure can be applied to coin processing devices other than the coin processing device 1 of the above embodiments that functions as a coin change machine. For example, this coin processing device can be combined with an information terminal device and a banknote processing device to configure an automated teller machine (ATM) installed in a financial institution, a convenience store, etc., a currency deposit and withdrawal machine or a teller system installed in a financial institution.

Furthermore, in the above embodiments, a coin processing device that processes coins such as depositing and dispensing is shown as an example of a currency processing device. However, the present disclosure can also be applied to a banknote processing device that processes banknotes such as a banknote change machine.

In addition, embodiments of the disclosure can be modified as appropriate within the scope of the claims.

1. A currency processing device, comprising:
a deposit port that receives currency inserted from outside of the currency processing device;
a transport including a circular transport path, the transport transporting the currency fed from the deposit port along the transport path;
a recognition sensor that recognizes the currency fed from the deposit port and transported on the transport path as one of normal and abnormal;
a currency storage in which the currency is stored;
a reject port for returning the currency; and
processing circuitry configured to control a currency storing process for storing the currency accepted by the deposit port into the currency storage, wherein to execute the currency storing process, the processing circuitry is configured to control the transport to
transfer the currency recognized as normal by the recognition sensor to the currency storage for storage in the currency storage, and
control the transport to transport the currency recognized as abnormal by the recognition sensor to be recirculated along the transport path to the recognition sensor to re-recognize the currency at least once, and to return the currency to the reject port based on a result of re-recognition by the recognition sensor.

2. The currency processing device according to claim 1, wherein the processing circuitry is further configured to control the transport to
in a case that the currency is recognized as abnormal by the recognition sensor less than a predetermined number of times, control the transport to recirculate the currency along the transport path to the recognition sensor to re-recognize the currency, and
in a case that the currency is recognized as abnormal the predetermined number of times or more, control the transport to transport the currency to the reject port for returning the currency out of the currency processing device.

3. The currency processing device according to claim 2, wherein the processing circuitry is further configured to execute a notification process to notify a user that the returned currency cannot be used when the currency is returned to the reject port.

4. The currency processing device according to claim 2, wherein the processing circuitry is further configured to
receive a number input to an input interface as the predetermined number of times, and
set the received number as the predetermined number of times.

5. The currency processing device according to a claim 2, wherein
the currency storing process further includes
a deposit process for storing deposited currency in the currency storage, and
a replenishment process for storing currency for replenishment in the currency storage, and
the processing circuitry is further configured to set a first predetermined number of times in the replenishment process to be less than a second predetermined number of times in the deposit process.

6. The currency processing device according to claim 1, wherein
the currency storing process includes
a deposit process for storing deposited currency in the currency storage, and
a replenishment process for storing currency for replenishment in the currency storage, and
the processing circuitry is further configured to:
in the depositing process, control the transport to transport the currency recognized as abnormal by the recognition sensor to be recirculated along the transport path so that the currency is re-recognized by the recognition sensor, and
in the replenishment process, returns the currency recognized as abnormal by the recognition normal to the reject port without being recirculated and re-recognized by the recognition sensor.

7. The currency processing device according to claim 1, wherein the processing circuitry is further configured to:
receive a setting for re-recognition by the recognition sensor, wherein the setting is input via an input interface, and the setting is either an on setting or an off setting;
in a case that the on setting is received, control the transport to transport the currency recognized as abnormal by the recognition sensor to recirculate along the transport path and the recognition sensor to re-recognize the currency; and
in a case that the off setting is received, return the currency recognized as abnormal by the recognition sensor to the reject port without being recirculated and re-recognized by the recognition sensor.

8. The currency processing device according to claim 1, wherein the processing circuitry is further configured to control a reconciliation process for reconciling the currency stored in the currency storage, wherein
to execute the reconciliation process, the processing circuitry is further configured to:
control the recognition sensor to recognize and count the currency transported on the transport path;
control the transport to transport the currency that is recognized as abnormal by the recognition sensor to be recirculated along the transport path and the recognition sensor to re-recognize the currency at least once; and
determine whether the currency is to be rejected based on a result of the re-recognition by the recognition sensor.

9. The currency handling device according to claim 1, wherein
the currency accepted by the deposit port is a coin,
the transport includes a circulating belt having a plurality of protrusions at predetermined intervals for transporting coins and circulating along the transport path,
the currency handling device further comprises a memory for storing, for each of the protrusions, status information for determining whether the protrusions are transporting coins respectively, and
the processing circuitry is further configured to, in a state in which the circulating belt is rotating:
in a case that a coin is fed from the deposit port to the protrusion, store information, indicating that the coin transported, in the memory as the status information;
in a case that the coin being transported by the protrusion is separated from the protrusion, store information, indicating that no coins are being transported, in the memory as the state information; and
control the deposit port to feed coins to the protrusion that has been determined not to be transporting coins based on the state information.

10. A currency processing device, comprising:
a transport including a circular transport path, the transport transporting currency fed from outside the currency processing device along the transport path;
a recognition sensor that recognizes the currency transported on the transport path as one of normal and abnormal;
a currency storage in which the currency is stored; and
processing circuitry configured to control a currency storing process for storing the currency into the currency storage, wherein to execute the currency storing process, the processing circuitry is configured to control the transport to
transfer the currency recognized as normal by the recognition sensor to the currency storage for storage in the currency storage, and
control the transport to transport the currency recognized as abnormal by the recognition sensor to be recirculated along the transport path to the recognition sensor to re-recognize the currency at least once, and to return the currency to a reject port based on a result of re-recognition by the recognition sensor.
